(19) United States
(12) Patent Application Publication
(10) Pub. No.: US 2005/0006310 A1
(43) Pub. Date: Jan. 13, 2005

(54) Purification and recovery of fluids in processing applications

(76) Inventors: Rajat Agrawal, Naperville, IL (US); James J.F. McAndrew, Homer Glen, IL (US); Ikuo Hirase, Plano, TX (US); Sylvie Lazure, Versailles (FR); Maurice Rignon, Seyssinet Pariset (FR); Hwa-Chi Wang, Naperville, IL (US); Nigel Betterton, Haute Jarrie (FR); Joseph E. Paganessi, Burr Ridge, IL (US)

Correspondence Address: Linda K. Russell;Patent Counsel, Air Liquide, 2700 Post Oak Blvd., Suite 1800, Houston, TX, 77056, US

(21) Appl. No.: 10/860,599

(22) Filed: Jun. 4, 2004

Related U.S. Application Data
(60) Provisional application No. 60/486,008, filed on Jul. 10, 2003.
(60) Provisional application No. 60/515,239, filed on Oct. 29, 2003.
(60) Provisional application No. 60/516,827, filed on Nov. 3, 2003.

(51) Int. Cl. C02F 1/00

(52) U.S. Cl. 210/640; 210/741

(57) ABSTRACT

A fluid purification and recovery system includes a buffer section configured to receive a fluid delivered from a process station, where the fluid pressure is maintained within the buffer section within a predetermined range and the fluid is maintained within the buffer section in at least one of a gas state, a liquid state and a supercritical state. The system further includes a purification section disposed downstream from the buffer section to receive the fluid from the buffer section, where the purification section includes at least one purification unit that separates at least a portion of at least one component from the fluid. In one embodiment, the fluid is maintained in at least one of a liquid state and a supercritical state in both the buffer section and the purification section. In addition, the buffer section delivers the fluid to the purification with minimal or substantially no fluctuations in pressure.

### CROSS-REFERENCE TO RELATED APPLICATIONS

This application claims priority from: U.S. Provisional Patent Application Ser. No. 60/486,008, entitled “On-site Purification of Carbon Dioxide in Liquid or Supercritical Phase”, and filed Jul. 10, 2003; U.S. Provisional Patent Application Ser. No. 60/515,239, entitled Methods to Concentrate Carbon Dioxide”, and filed Oct. 29, 2003; and U.S. Provisional Patent Application Ser. No. 60/516,827, entitled “Separation and Recovery from Supercritical Fluids”, and filed Nov. 3, 2003. The disclosures of these provisional patent applications are incorporated herein by reference in their entireties.

### BACKGROUND OF INVENTION

1. Field of Invention

The present invention pertains to purification and recovery of fluids in processing applications. In particular, the present invention relates to systems and methods for supplying, purifying and recovering fluids such as carbon dioxide in semiconductor cleaning and other processing applications.

2. Related Art

The use of supercritical fluids such as carbon dioxide in cleaning operations (e.g., dry cleaning and cleaning parts and components) has been on the rise in recent years as a replacement for organic solvents and other potentially toxic and environmentally unfriendly chemicals. In particular, supercritical carbon dioxide (SCCO₂) has zero surface tension and very high diffusivity, which makes this fluid very attractive for use in semiconductor fabrication processes such as cleaning of wafers and photoresist removal. Carbon dioxide is in a supercritical state at a temperature of about 31° C. or greater and a pressure of about 1080 pounds per square inch gauge (psig) (about 74.46 bar) or greater.

In semiconductor cleaning operations, it is important to provide the supercritical carbon dioxide at a high purity level to reduce or eliminate the presence of undesirable contaminants contacting the substrate surface in a semiconductor process chamber. Accordingly, the carbon dioxide stream is typically purified in one or more purification steps prior to being delivered to the process chamber for cleaning of the semiconductor component.

In a typical semiconductor cleaning process, carbon dioxide is drawn from a supply source (e.g., a storage or feed tank), where the carbon dioxide is stored at a liquid state (e.g., at a temperature of about −20° C. to about −10° C. and a pressure of about 300 psig or 20.68 bar). The liquefied carbon dioxide is pressurized and heated to achieve a supercritical state prior to delivery to the process chamber for cleaning the semiconductor substrate. After the cleaning step, the carbon dioxide is treated in one or more purification units to remove contaminants (e.g., photoresist and/or other compounds) and/or additives such as co-solvents from the carbon dioxide. The carbon dioxide can be purified to a desired level and recycled for further use in the process chamber or, alternatively, vented to the atmosphere. If the carbon dioxide is recycled for further use, the carbon dioxide stream is typically purified and processed in a gaseous state. At some point prior to re-use, the carbon dioxide must be re-pressurized from the gaseous state to achieve a supercritical state.

The problem with re-pressurizing carbon dioxide during a recycle process is that considerable energy and equipment costs are required to convert the carbon dioxide from gaseous back to liquid and supercritical states. In addition, re-pressurization of the carbon dioxide may result in the addition of impurities to the carbon dioxide stream. For example, depending upon the number of pumps and high pressure piping and valves utilized, sealing material for the high pressure piping lines can become entrained in the carbon dioxide at a point downstream from the purification units, such that the recycled supercritical carbon dioxide is no longer at a desired purity level prior to entry into the process chamber.

Another problem that is associated with the fluid purification and recycling is maintaining steady state conditions for the fluid effluent stream emerging from the process chamber. When cleaning with supercritical fluid in a process chamber, the pressure of the cleaning fluid is typically modulated or cycled to improve mixing of the fluid and cleaning of the component within the chamber. The pressure cycling can vary by as much as 10-50% from a median pressure value. In addition, the process chamber is typically depressurized from the processing pressure to atmospheric pressure after cleaning to facilitate removal of the component from the chamber. These pressure fluctuations can significantly affect the pressure and temperature of the fluid effluent downstream from the process chamber, which in turn can be detrimental to the performance of the purification processing steps for the effluent. Thus, it is very important to eliminate pressure and temperature fluctuations of the fluid during purification.

### SUMMARY OF THE INVENTION

It is an object of the present invention to provide a system for supply and/or purification and recovery of fluids that provides a stream of fluid at suitable temperature and pressure conditions as well as an acceptable purity level to a process chamber.

It is another object of the present invention to provide a supply and/or purification and recovery system that removes entrained contaminants and/or co-solvents from a fluid stream after processing within the process chamber.

It is a further object of the present invention to provide a supply and/or purification and recovery system that reduces energy and equipment costs associated with providing recycled fluids to a process chamber at suitable temperature and pressure conditions.

It is yet another object of the present invention to provide a supply and/or purification and recovery system that minimizes or eliminates pressure and temperature fluctuations of the fluids at a location downstream from the process chamber prior to processing in one or more purification units.

The aforesaid objects are achieved individually and/or in combination, and it is not intended that the present invention be construed as requiring two or more of the objects to be combined unless expressly required by the claims attached hereto.

In accordance with the present invention, a fluid purification and recovery system includes a buffer section configured to receive a fluid delivered from a process station, where the fluid pressure is maintained within the buffer section within a predetermined range and the fluid is maintained within the buffer section in at least one of a gas state, a liquid state and a supercritical state. The system further includes a purification section disposed downstream from the buffer section to receive the fluid from the buffer section, where the purification section includes at least one purification unit that separates at least a portion of at least one component from the fluid. In one embodiment, the fluid is maintained in at least one of a liquid state and a supercritical state in both the buffer section and the purification section. In addition, the buffer section delivers the fluid to the purification section with minimal or substantially no fluctuations in pressure.

In another embodiment of the present invention, a fluid purification and recovery system includes a fluid supply source connectable at an upstream location with a process station to provide fluid to the process station, and a purification section including at least two purification units located at a downstream location from and connectable with the process station to receive fluid exiting the process station. The purification units of the purification section remove at least one component from the fluid while the fluid is maintained in at least one of a supercritical state and a liquid state.

The purification section can include any suitable number, combination and/or types of purification units including, without limitation, adsorption units, oxidation units, distillation units, absorber units, filters, coalescers and mechanical separation units.

The above and still further objects, features and advantages of the present invention will become apparent upon consideration of the following detailed description of specific embodiments thereof, particularly when taken in conjunction with the accompanying drawings wherein like reference numerals in the figures are utilized to designate like components.

### BRIEF DESCRIPTION OF THE DRAWINGS

FIG. 1 is a diagram of an exemplary embodiment of a fluid supply, purification and recovery system in accordance with the present invention.

FIG. 2 is a diagram of a portion of a modified embodiment of the system of FIG. 1 employing multiple process chambers within the fluid supply, purification and recovery system in accordance with the present invention

FIG. 3 is a diagram of an alternative exemplary embodiment of a fluid purification and recovery system in accordance with the present invention.

### DESCRIPTION OF PREFERRED EMBODIMENTS

In accordance with the present invention, a fluid supply and/or purification and recovery system includes on-site purification of the fluid, where the fluid is preferably in supercritical and/or liquid state during at least one purification step. More preferably, the fluid is maintained in supercritical and/or liquid state during the entire purification process so as to minimize and reduce energy requirements associated with achieving a desired pressure and temperature of the fluid prior to introduction into a process chamber. In addition, the system includes a buffer unit and/or other system components that maintain steady state temperature and pressure conditions of the fluid effluent at a location downstream from the process chamber and upstream or prior to being purified in one or more purification units. The process fluid is preferably carbon dioxide. However, while the systems are described below in terms of utilizing carbon dioxide, it is noted that the invention contemplates the use of any one or combination of process fluids including, without limitation, carbon dioxide, alkyls (e.g., ethane, ethylene, propane, propylene, etc.), water and ammonia.

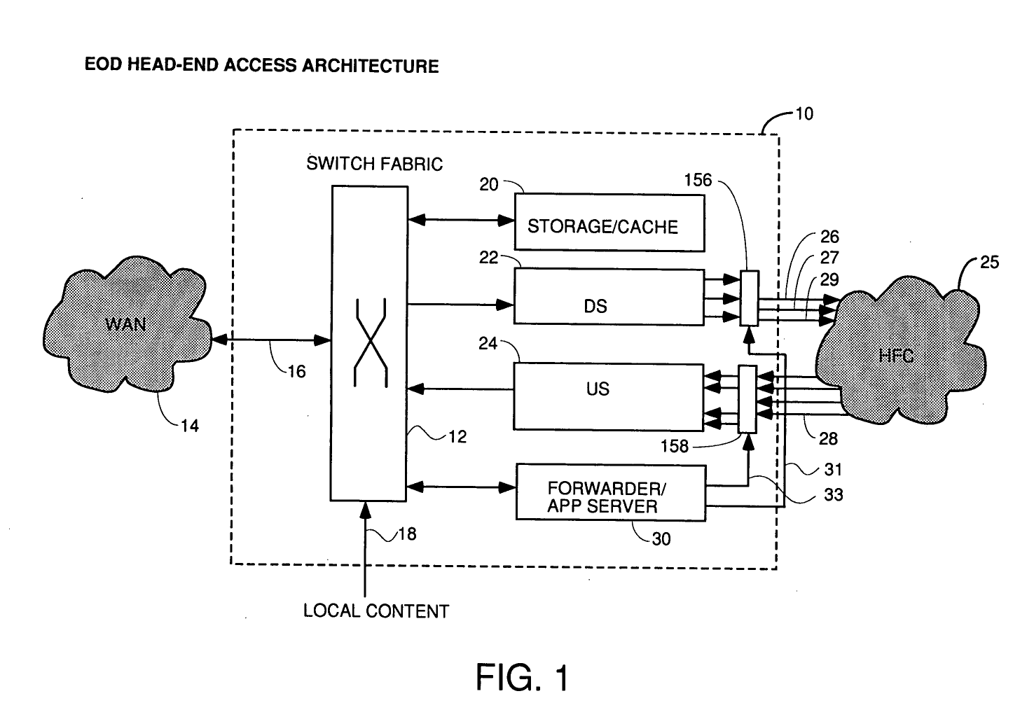

An exemplary embodiment of a carbon dioxide supply, purification and recovery system is depicted in FIG. 1. In particular, the system 2 includes a carbon dioxide supply source 10 that supplies carbon dioxide to a process station. The process station is a process chamber 40 for semiconductor cleaning and other processing applications, where supercritical carbon dioxide is provided during one or more processing steps during fabrication of one or more semiconductor wafers. For example, the processing step may include cleaning to removing or stripping photoresist or residue from a semiconductor wafer. Alternatively, it is noted that the system can be implemented with any other process station in which supercritical fluids are utilized to clean and process components or articles.

The carbon dioxide at the supply source 10 is preferably in a liquid state, at a temperature in a range of about −20° C. to about 25° C. (e.g., about room temperature or slightly greater) and a pressure in a range of about 300 psig (20.68 bar) to about 300 psig (57.23 bar) (e.g., the vapor pressure of carbon dioxide at about room temperature). The source 10 may include one or more storage or feed tanks, a carbon dioxide tank trailer or, alternatively, an on-site carbon dioxide plant such as a steam methane reformer. The carbon dioxide source 10 provides an initial carbon dioxide feed to the process chamber 40 and can provide additional, make-up feed to be combined with recycled and purified carbon dioxide effluent as described below.

The liquid carbon dioxide from the feed source 10 is pressurized in a pressurization unit 12 (e.g., one or more pumps) disposed at a suitable location downstream from the feed source. Pressurization of the carbon dioxide can be in a single stage or multiple stages to achieve a suitable pressure for the carbon dioxide stream. Preferably, the pressure of the carbon dioxide is increased by the pressurization unit to above the critical pressure for carbon dioxide (about 1080 psig or 74.46 bar).

The pressurized carbon dioxide is fed from the pressurization unit 12 to a first purification section 20 to purify the carbon dioxide to a desired level or degree while maintaining the carbon dioxide in a liquid or supercritical state and prior to being used in the process chamber. Any suitable number (e.g., one or more), combination and/or types of purification devices may be utilized in the first purification system depending upon the degree of purification desired and the types of contaminants that are to be removed. Exemplary types of purification devices include, without limitation, adsorption units (e.g., pressure swing adsorption units, vacuum swing adsorption units, thermal swing adsorption units, etc.), absorber units, distillation units, filtration units (e.g., one or more filters with selected mesh sizes), catalytic oxidation units, coalescer units and mechanical separators (e.g., cyclonic separators).

In the exemplary embodiment of FIG. 1, the first purification section 20 includes an adsorption unit 22 and an oxidation unit 24 disposed downstream from the adsorption unit to facilitate the removal of water and various organic compounds from the carbon dioxide while in liquid or supercritical state. The arrangement of the adsorption unit and oxidation unit in this manner can be selected to take advantage of low temperature adsorption (where the carbon dioxide is in liquid state) followed by oxidation (in liquid or supercritical state). However, in situations where certain compounds to be removed from the carbon dioxide are detrimental to the adsorption process, the adsorption unit may be arranged downstream from the oxidation unit to facilitate removal of these compounds prior to processing in the adsorption unit.

The adsorption unit 22 can be any one or combination of suitable devices, such as an activated carbon bed, a molecular sieve and/or a low-silica zeolite to facilitate removal of water and/or high molecular weight hydrocarbons from the liquid or supercritical carbon dioxide stream. The adsorption unit can further be regenerated by pressure swing, vacuum swing or thermal swing methods. Exemplary pressures for the carbon dioxide stream within the adsorption unit are in the range of about 1080 psig (74.46 bar) to about 3500 psig (241.3 bar), while exemplary temperatures for the carbon dioxide stream in the adsorption unit are in the range of about −20° C. to about 50° C.

The carbon dioxide stream is delivered from the adsorption unit 22 (e.g., in a liquid state) to the oxidation unit 24, where it is combined with oxygen and exposed to a suitable catalyst (e.g., platinum, palladium, alumina, nickel, etc.) to oxidize and separate lower molecular weight organic contaminants from the carbon dioxide stream. Exemplary pressures for the carbon dioxide stream within the oxidation unit are in the range of about 1080 psig (74.46 bar) to about 3500 psig (241.3 bar), while exemplary temperatures for the carbon dioxide stream in the oxidation unit are in the range of about 100° C. to about 500° C.

Oxygen is introduced into the oxidation unit 24 from an oxygen supply source 26, with the amount of supplied oxygen being controlled by an adjustable control valve 28 disposed in-line between the oxygen supply source 26 and the oxidation unit 24. A hydrocarbon analyzer and controller 23 communicates (e.g., via electrical wiring and/or wireless communication) with the control valve 28 and a sensor disposed in-line between the adsorption unit 22 and the oxidation unit 26. The sensor measures the amount of one or more hydrocarbons in the carbon dioxide stream, and the controller 23 effects manipulation of the valve 28 accordingly to adjust the amount of oxygen supplied to the oxidation unit. This feed forward loop control of oxygen ensures that a sufficient amount of oxygen is provided to substantially oxidize hydrocarbons within the oxidation unit while preventing excessive amounts of oxygen from entering the carbon dioxide stream. For example, when the organic contaminant within the carbon dioxide stream emerging from the adsorption unit changes slowly, the oxygen level can be controlled within a range of about 10 ppm to about 100 ppm.

Alternatively, or in addition to the feed forward loop described above, a feedback control loop may be provided to measure oxygen in the carbon dioxide stream at the outlet of the oxidation unit. In the feedback control loop, an oxygen analyzer measures the oxygen content in the carbon dioxide stream emerging from the oxidation unit, via an oxygen sensor disposed in-line downstream from the oxidation unit, and effects manipulation of the valve 28 accordingly to control the flow of oxygen to the oxidation unit.

The oxidation unit can utilize oxidizing mediums other than or in addition to oxygen. For example, ozone, which has a substantially higher oxidation capability than oxygen, can be utilized. Alternatively, ultraviolet (UV) light can be used in combination with ozone and/or oxygen to generate oxygen radicals. The use of ozone and/or UV light can eliminate the need for a catalyst in certain situations. Other oxidizing agents, such as hydrogen peroxide, fluorine, potassium permanganate, can also be used.

Additional adsorption and/or other purification units may also be provided in the first purification section 20 downstream from the oxidation unit 24, particularly when the carbon dioxide stream is known to contain large organic contaminant levels for a particular application. For example, a stripper column can be situated at a suitable location downstream from the oxidation unit. In addition, in situations where large spikes in organic contaminants occur, an excess supply of oxygen may be injected into the carbon dioxide stream at a location upstream from the oxidation unit to ensure that organic compounds within the stream are substantially or completely oxidized even when such compounds are present at the high concentration levels within the stream. In another exemplary embodiment, a distillation unit can be provided in the first purification section to remove low boiling point gases from liquid carbon dioxide prior to being delivered to the process chamber.

An oxygen destruct unit 32 is optionally disposed downstream from the first purification section 20 to remove excess oxygen from the carbon dioxide stream prior to being delivered to the process chamber. Alternatively, if a stripper column is provided downstream from the oxidation unit, the oxygen destruct unit is not necessary since excess oxygen would be removed in the stripper column. Exemplary pressures for the carbon dioxide stream within the oxygen destruct unit are in the range of about 1080 psig (74.46 bar) to about 3500 psig (241.3 bar), while exemplary temperatures for the carbon dioxide stream in the oxygen destruct unit are in the range of about −20° C. to about 50° C.

The liquefied or supercritical carbon dioxide stream exits the oxygen destruct unit 32 and is directed through a heat exchanger 33 prior to being fed into a process chamber 40. Preferably, the heat exchanger provides indirect heat exchange to the carbon dioxide stream to minimize or prevent further contaminants from entering the stream. The carbon dioxide stream is heated within the heat exchanger 33 to a suitable temperature above the critical temperature of carbon dioxide (i.e., above about 31° C.) to ensure the carbon dioxide stream is in supercritical state upon entering the process chamber 40.

Additives, such as co-solvents and surfactants, are typically added to carbon dioxide to change the polarity of the carbon dioxide to facilitate the dissolving of certain organic compounds into the carbon dioxide stream during a semiconductor cleaning process. Any suitable number (e.g., one or more) and/or combination of additives may be utilized including, without limitation, alcohols (e.g., methanol, ethanol, isopropyl alcohol, etc.), halogenated, saturated, unsaturated or aromatic hydrocarbons, amines (e.g., dimethylamine, diethylamine, triethylamine, pyridine, etc.), aldehydes, anhydrides, organic and inorganic acids (e.g., acetic acid, hydrofluoric acid), ketones, esters, glycols, and fluoride containing materials (e.g., ammonium fluoride).

Specific additives can be provided to remove specific contaminants during a cleaning process. For example, chelating agents such as hexafluoroacetylacetone can be provided to remove certain metals such as copper. Other additives can be provided for certain processes other than cleaning. For example, copper compounds can be added to the carbon dioxide stream to enhance a copper deposition processing step, and silicon and organosilicon compounds can be provided in the carbon dioxide stream for dielectric deposition processing steps.

Additives can be injected directly into the supercritical carbon dioxide stream at a suitable location upstream from the process chamber and/or directly into the process chamber. In the embodiment of FIG. 1, an additive stream 34 is injected into the supercritical carbon dioxide stream at a location immediately upstream from the process chamber 40.

The carbon dioxide stream is fed to the process chamber 40 to perform a particular processing step in the fabrication of a component (e.g., cleaning residue such as photoresist from a semiconductor wafer). The carbon dioxide stream then leaves the process chamber 40 entrained with contaminants from the processing step and is sent to a recovery section including a buffer section and a second purification section as described below.

A buffer section 42 is disposed downstream from the process chamber 40 and is configured to receive the carbon dioxide effluent exiting the process chamber and establish steady state pressure and temperature conditions for the carbon dioxide prior to further processing. As noted above, it is important to eliminate pressure fluctuations in the carbon dioxide stream prior to purifying the carbon dioxide. The buffer section stabilizes the pressure and temperature of the carbon dioxide effluent stream prior to delivery of the stream to a second purification section 50 described below.

The buffer section can include one or any combination of a vessel or tank, a pressure pulse dampener unit, a pipe section having suitable inner diameter dimensions, or any other suitable device (e.g., valves, pressure regulators, etc.) capable of stabilizing the pressure of the carbon dioxide. In a preferred embodiment, the buffer section includes a buffer tank that includes a heat exchanger or other heat control device (e.g., a heating jacket) and at least one pressure regulator disposed downstream from the tank to regulate the pressure of the carbon dioxide stream to a steady state level. In addition, one or more flow control valves may be aligned at upstream and/or downstream locations from the buffer tank to assist in maintaining the pressure of the carbon dioxide stream within the buffer section within a steady state range. Exemplary pressure ranges for the carbon dioxide effluent within the buffer section are in the range of about 550 psig (37.92 bar) to about 4000 psig (275.8 bar), preferably in the range of about 1000 psig (68.95 bar) to about 2500 psig (172.4 bar), while temperature ranges for the effluent are preferably within the range of about 0° C. to about 70° C.

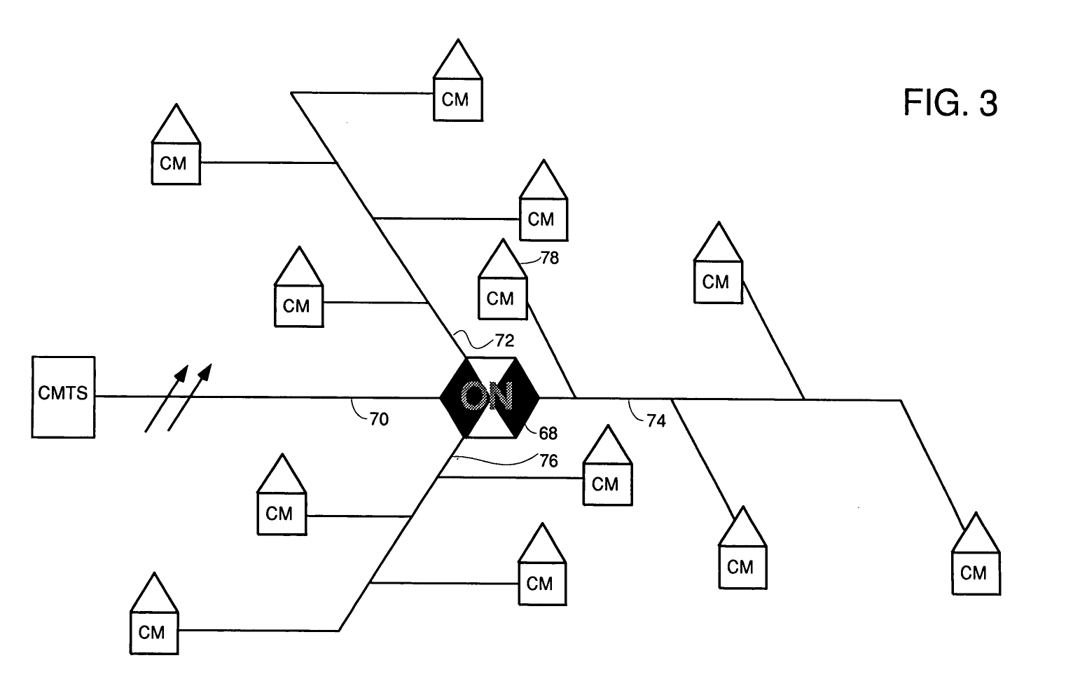

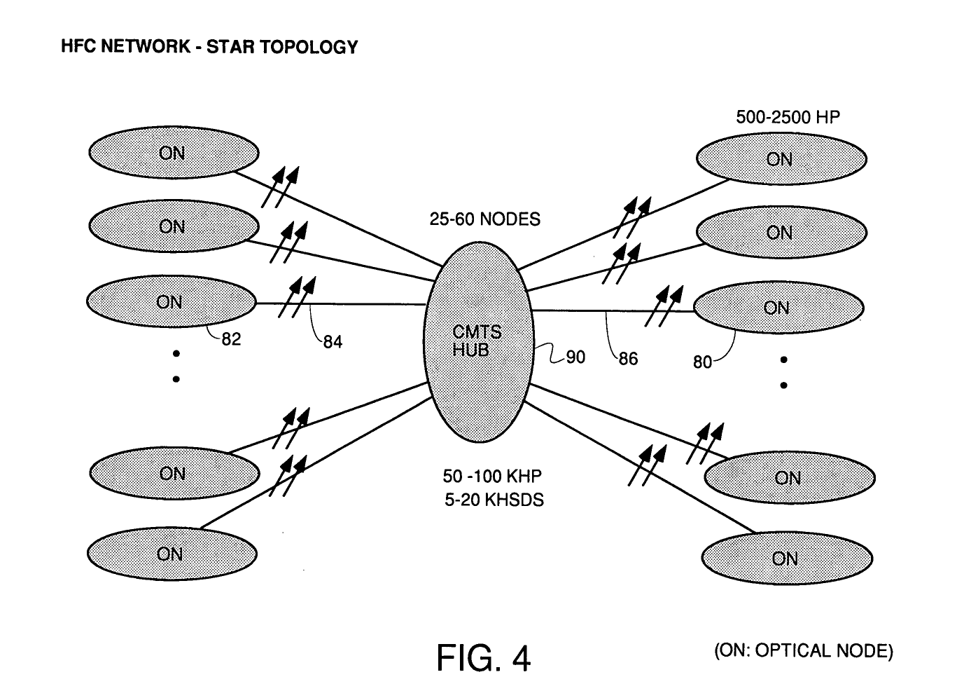

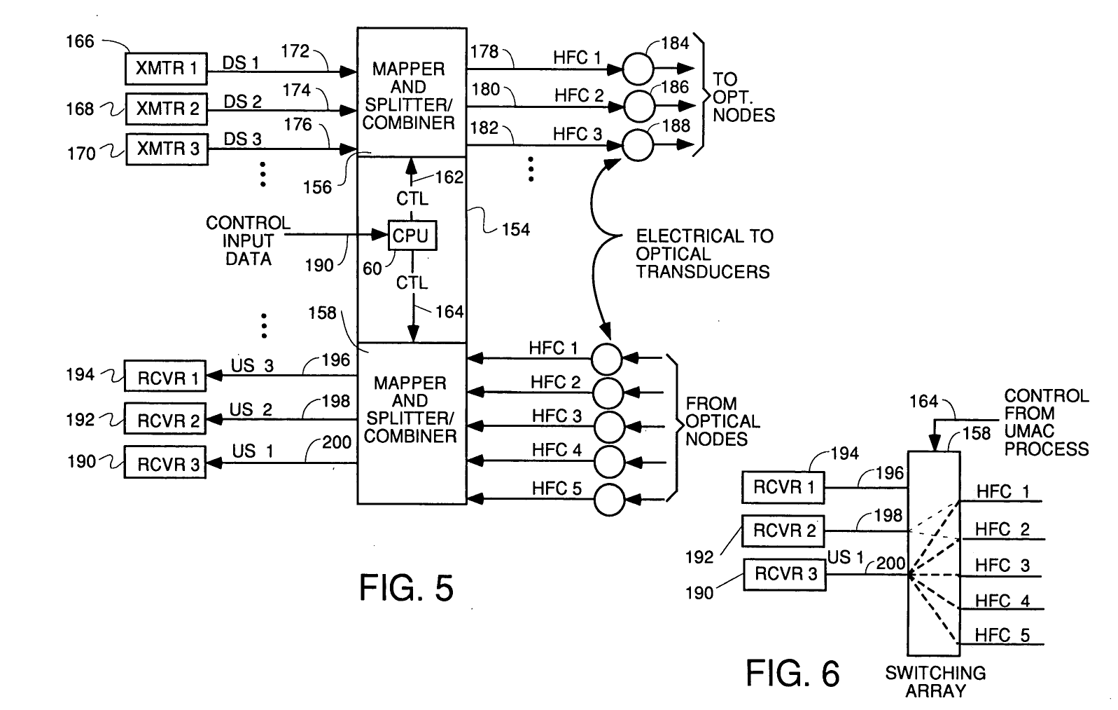

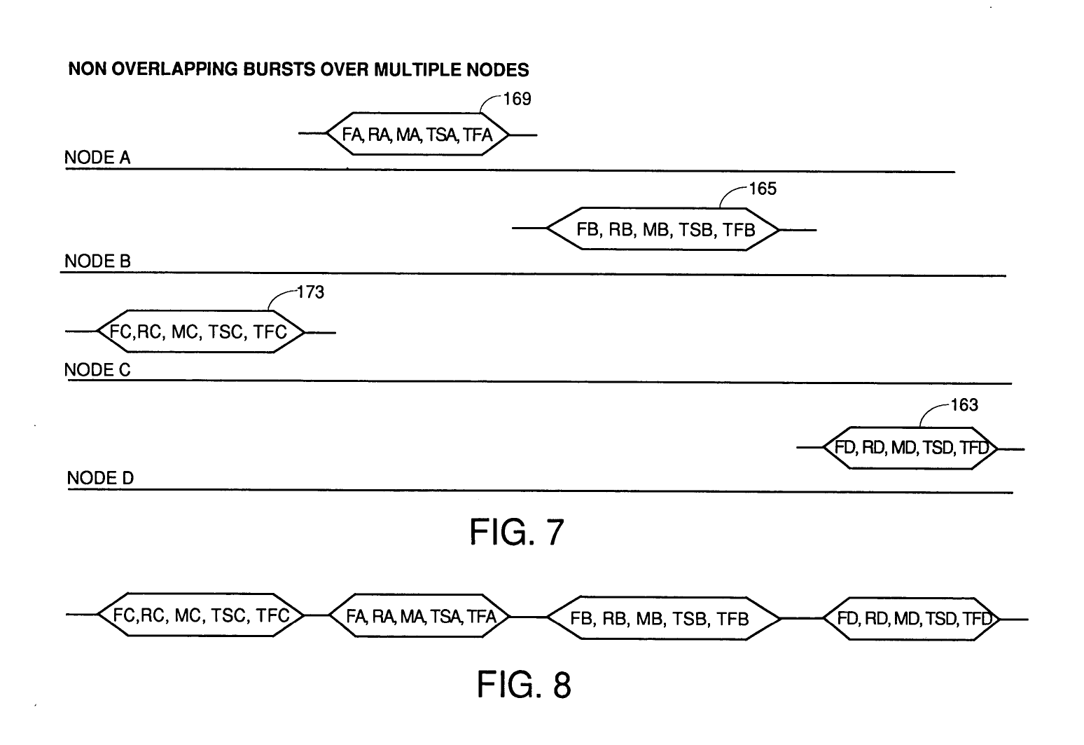

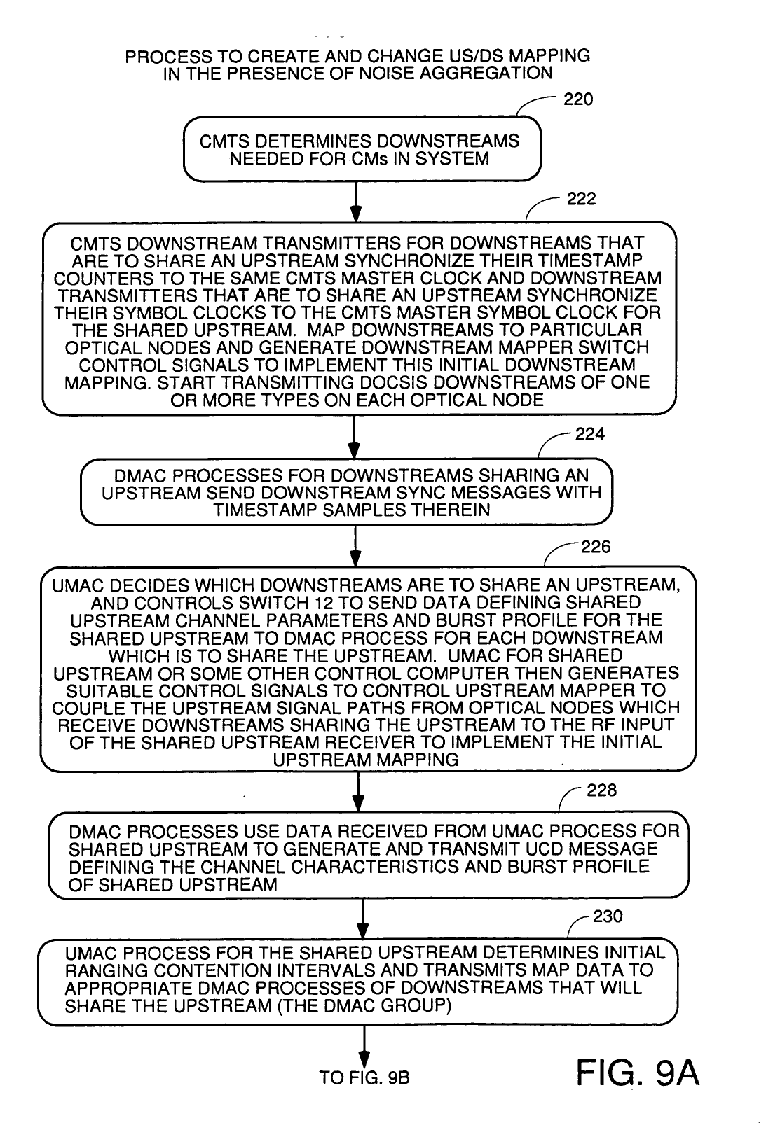

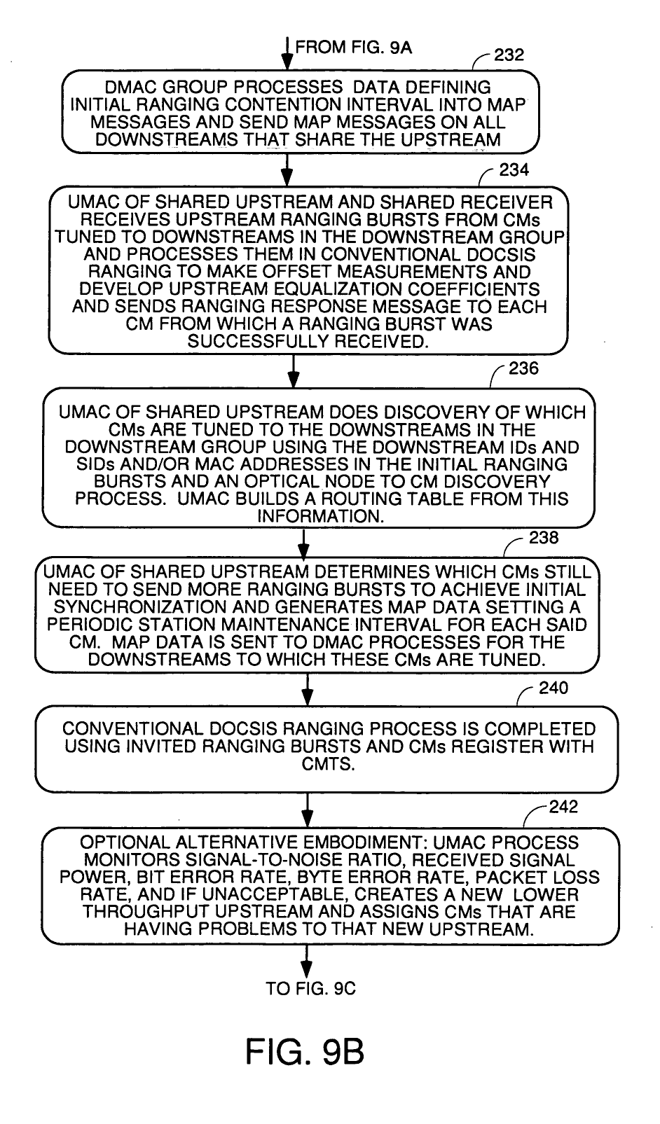

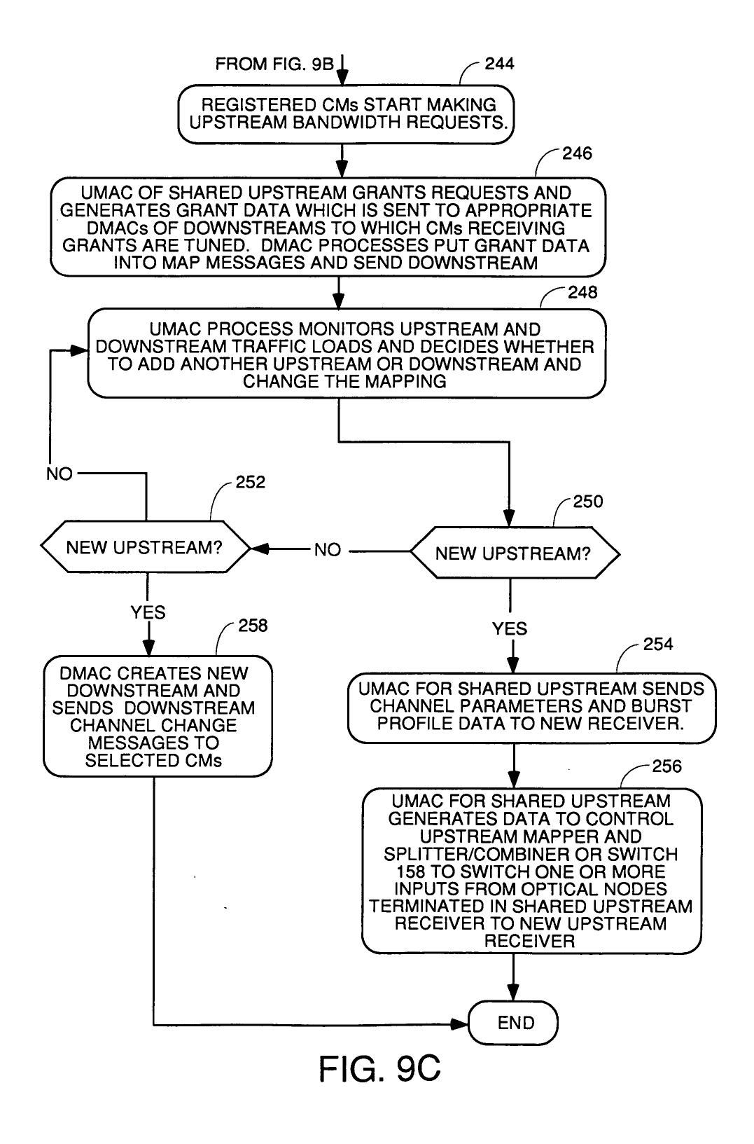

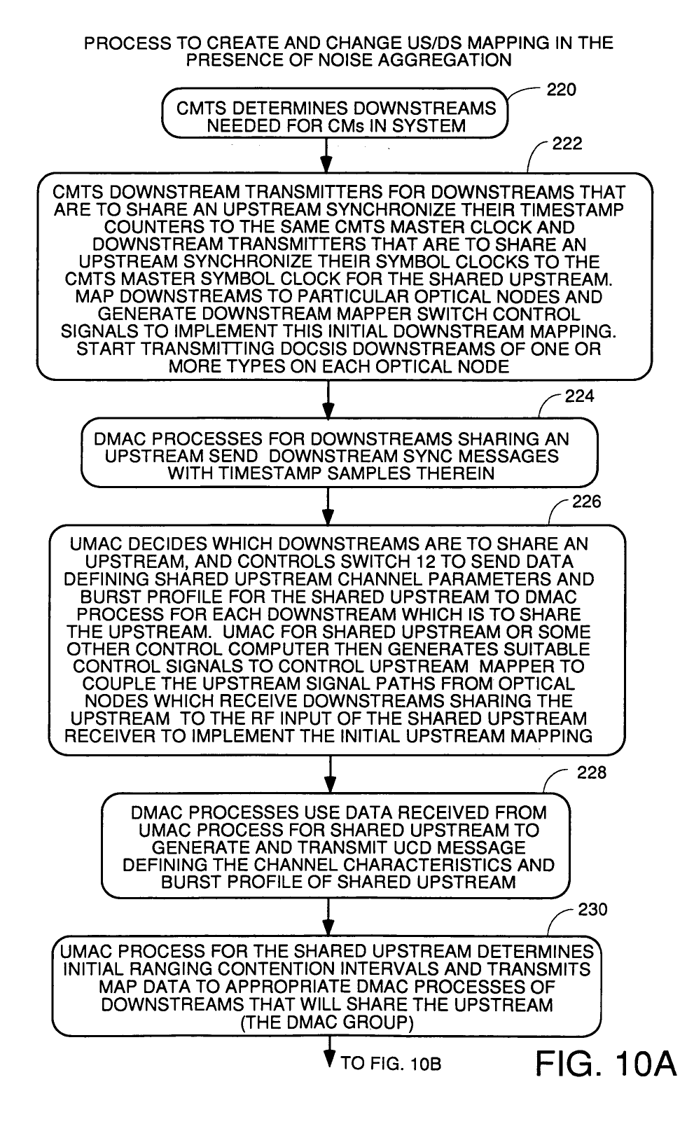

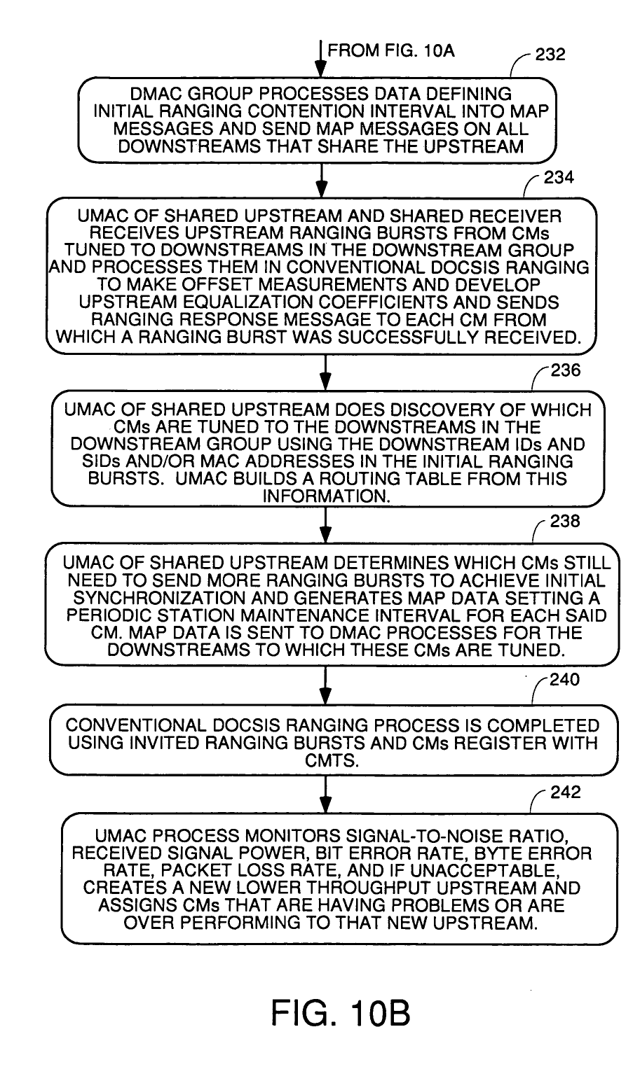

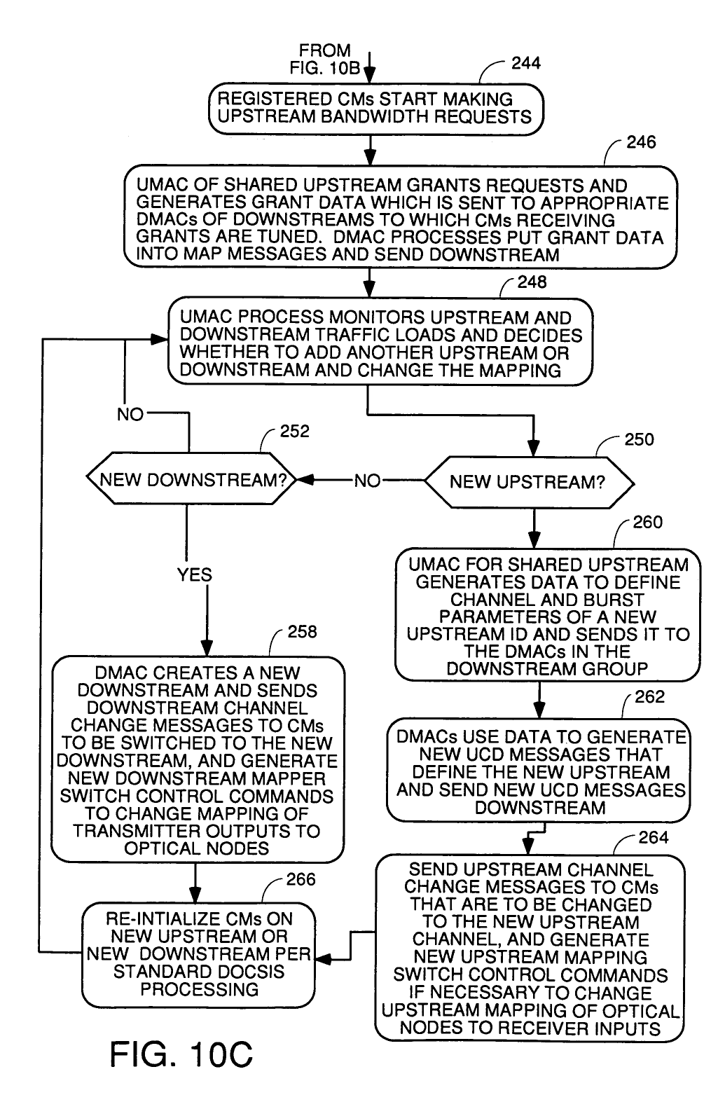

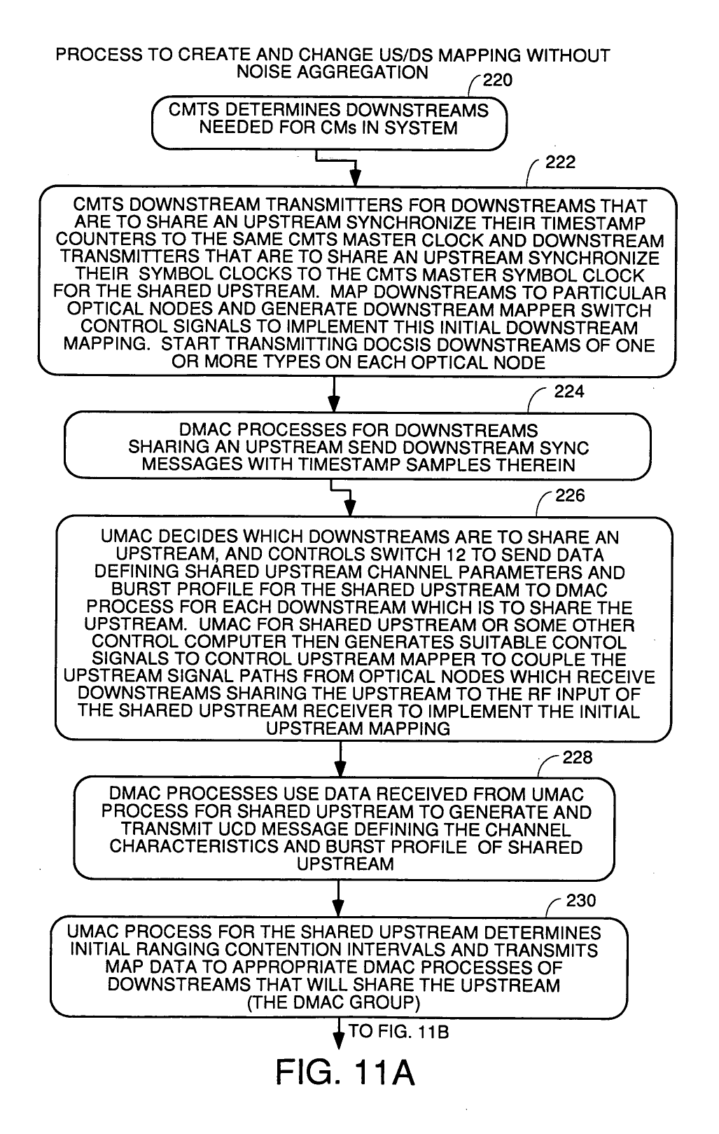

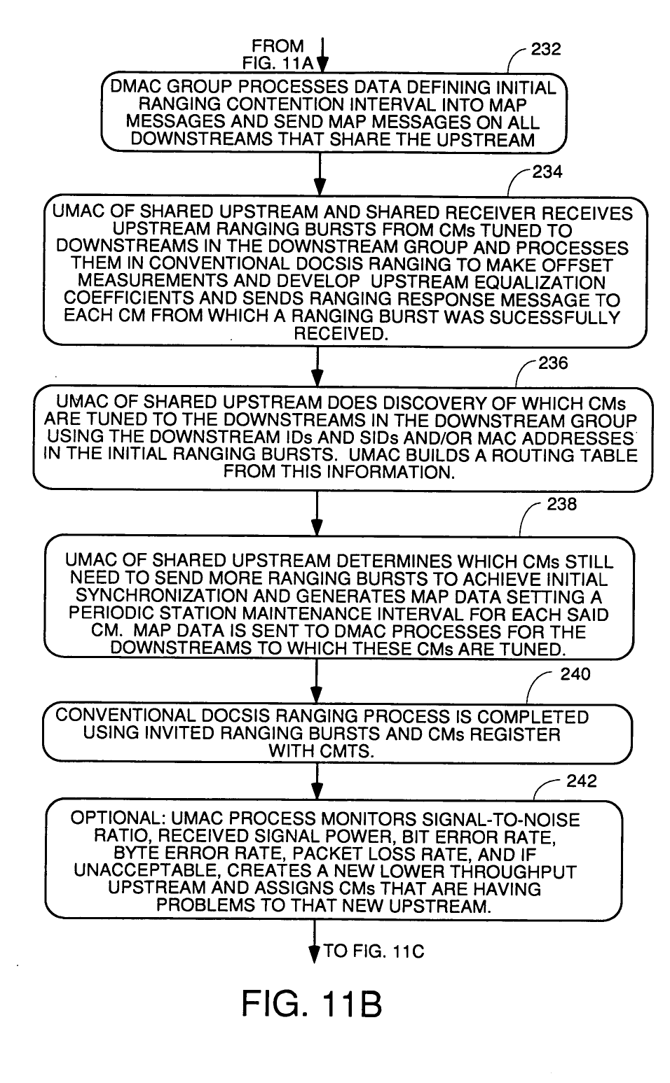

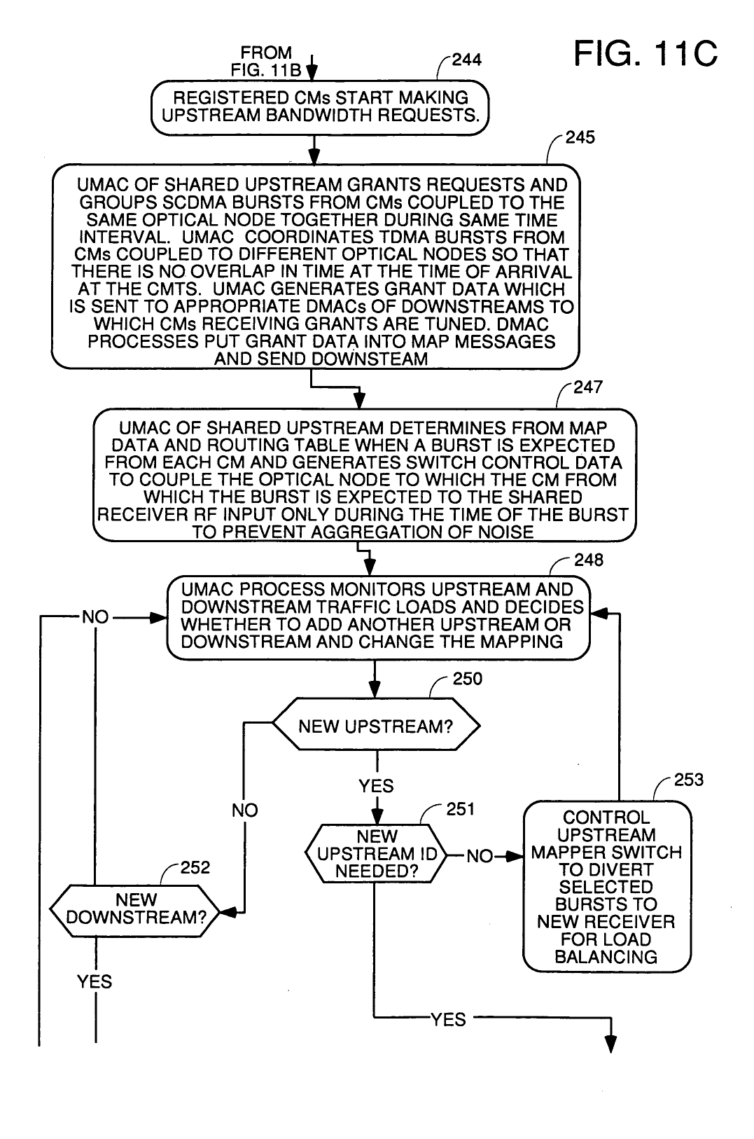

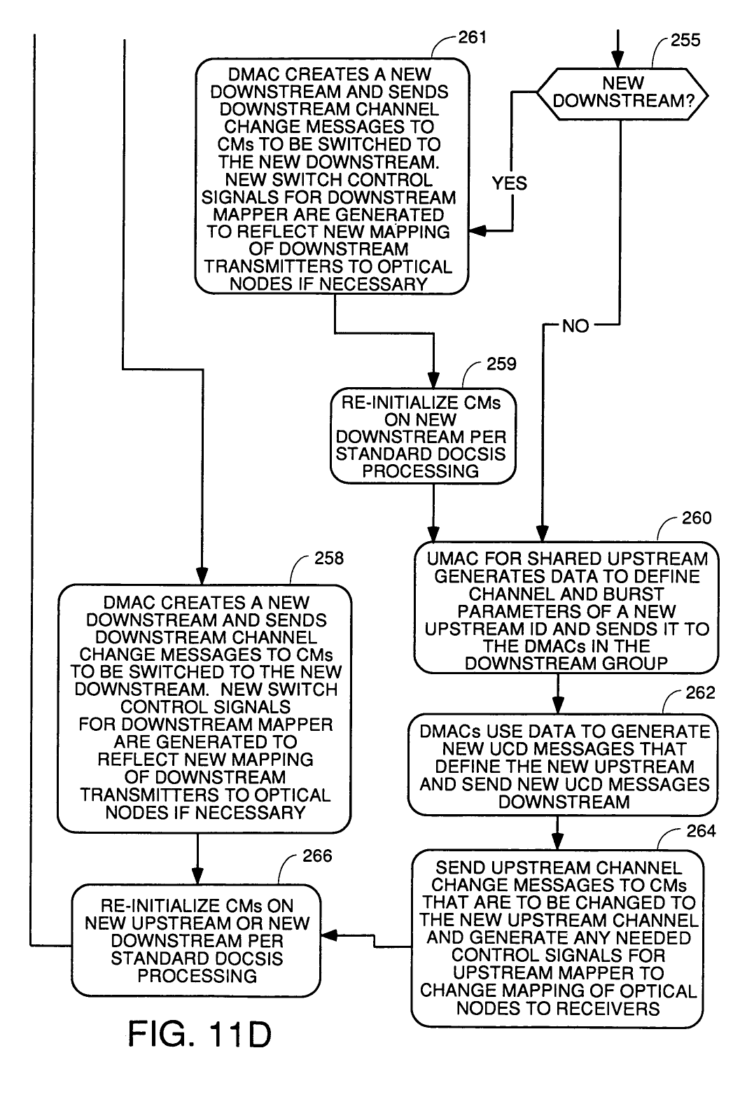

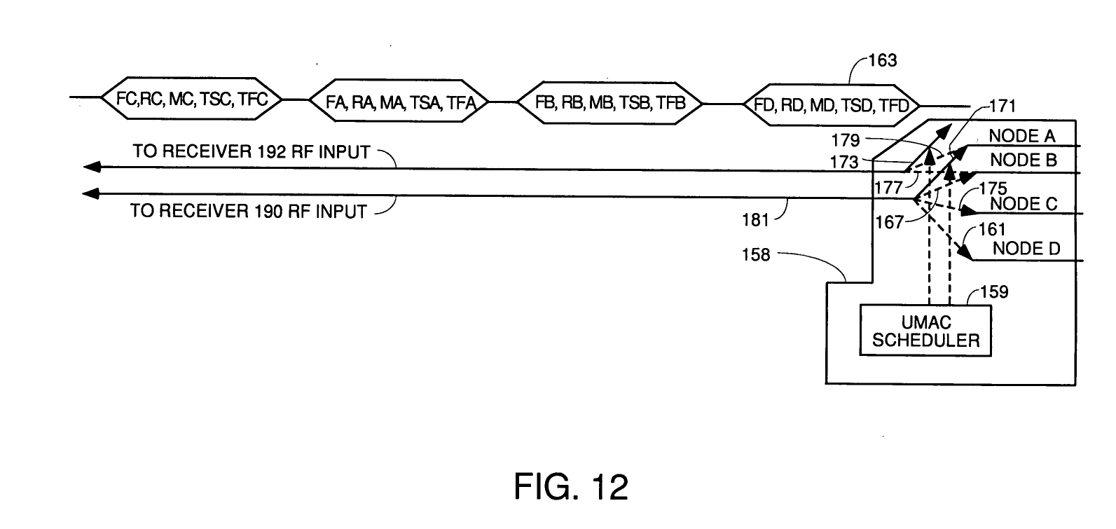

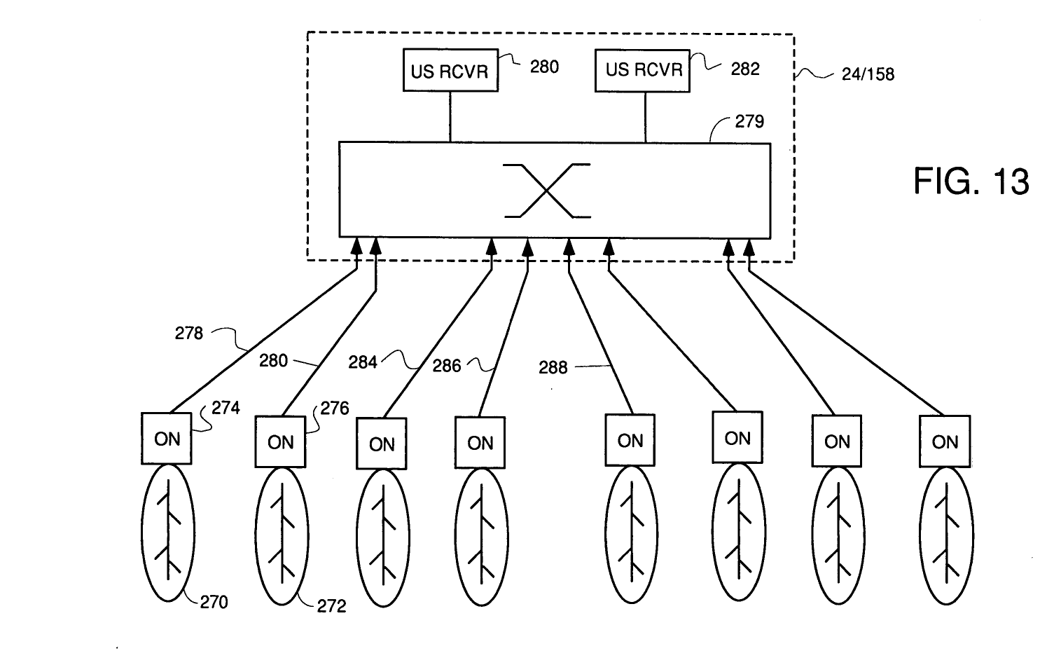

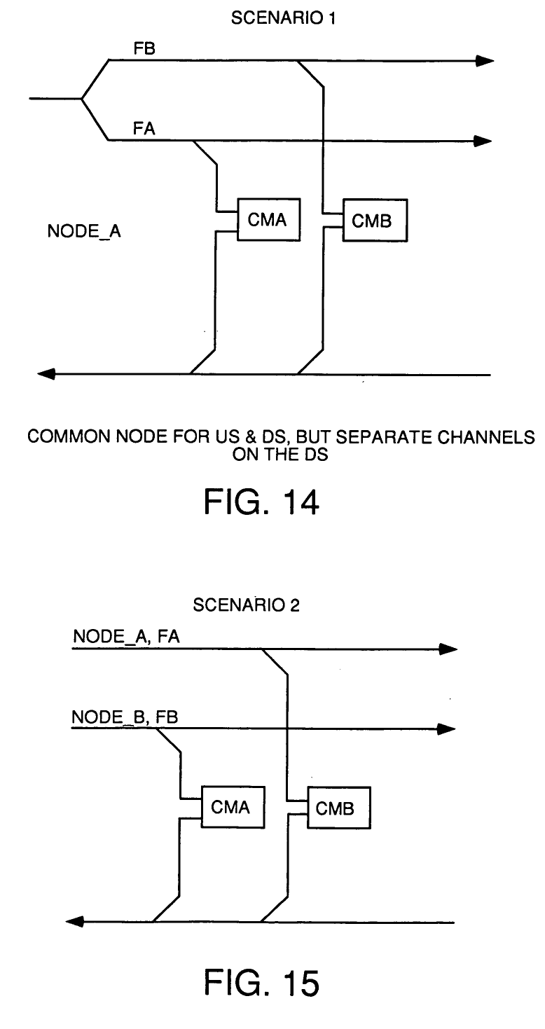

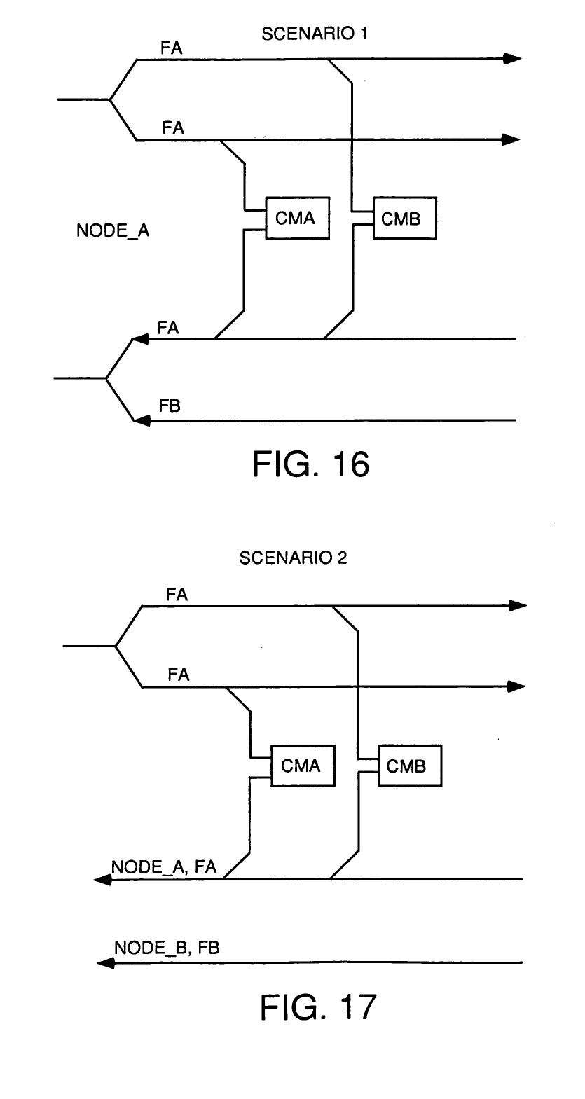

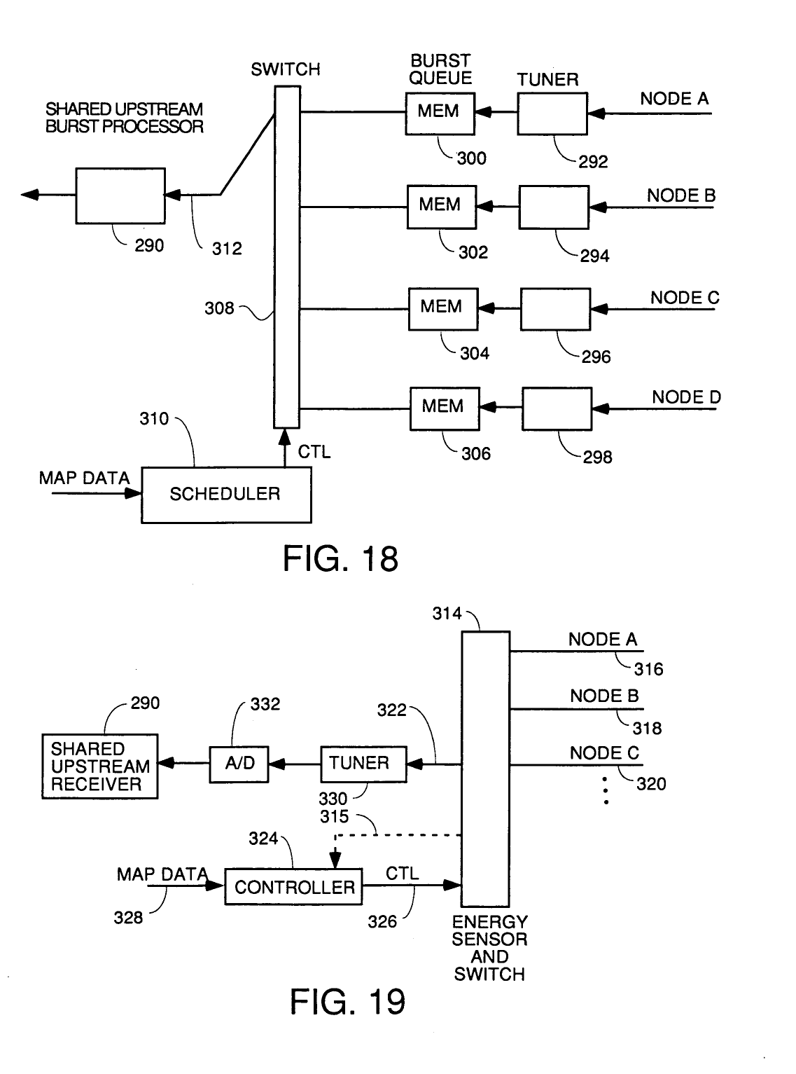

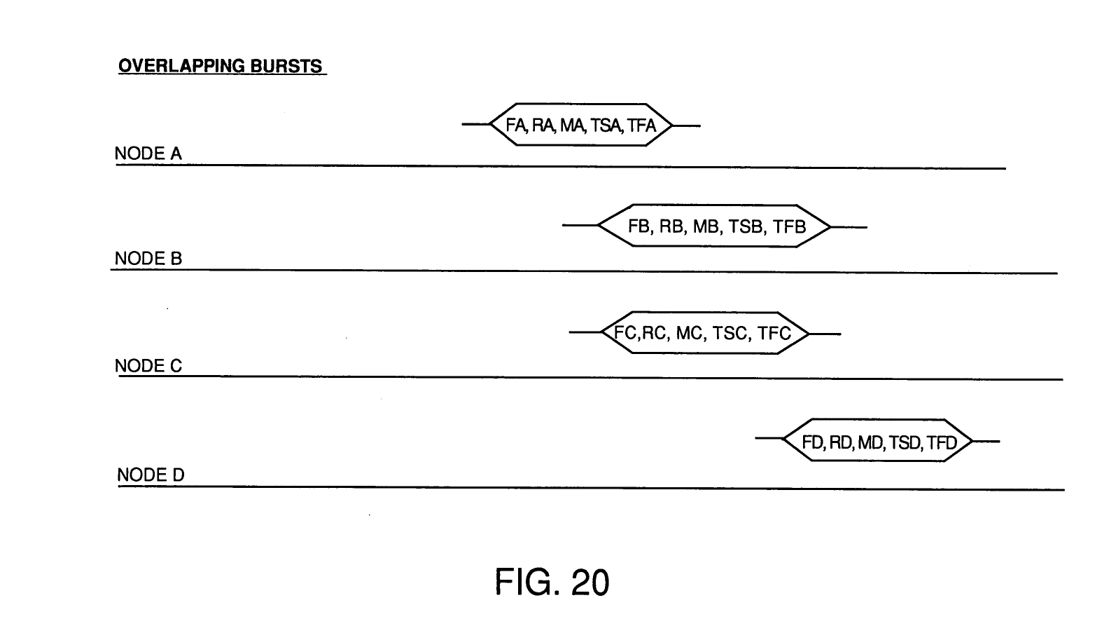

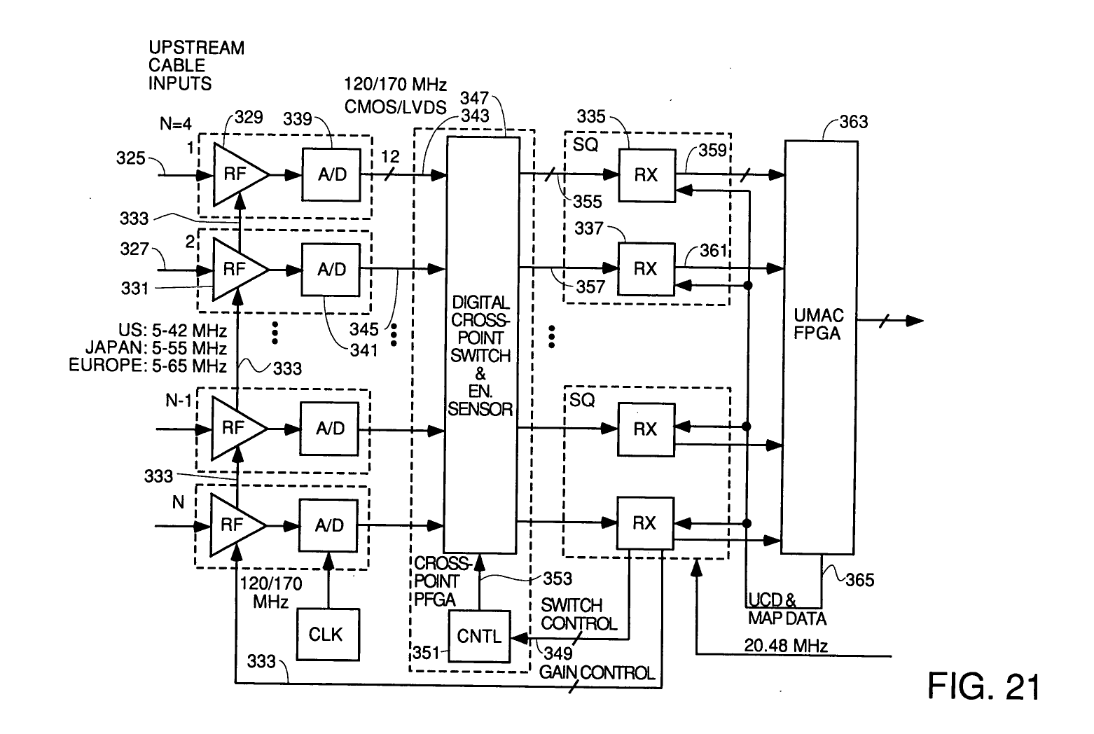

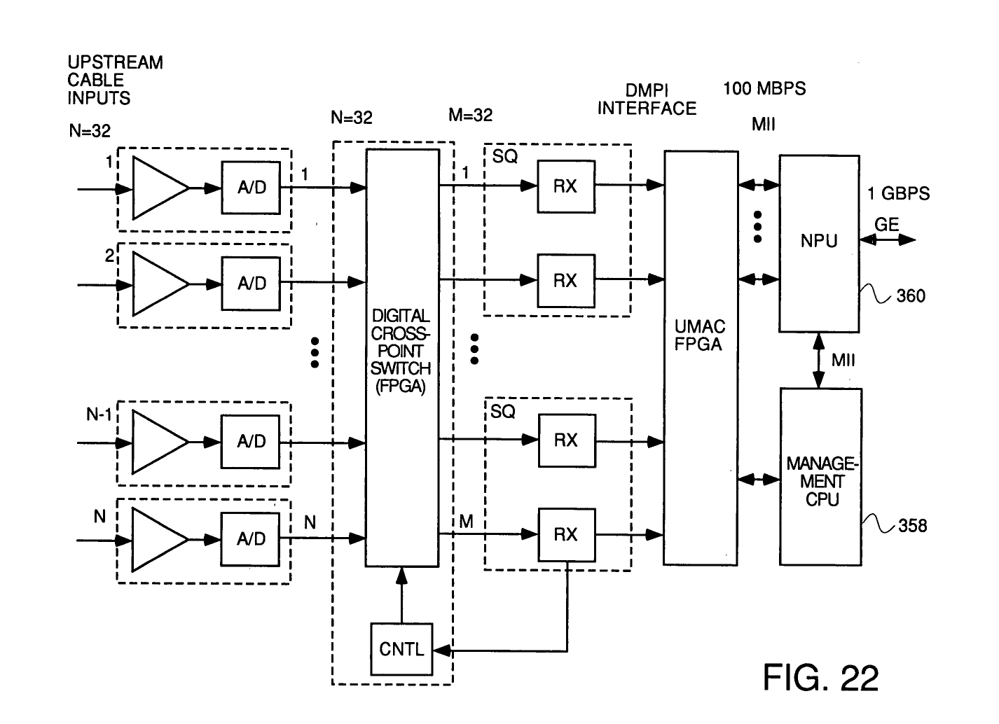

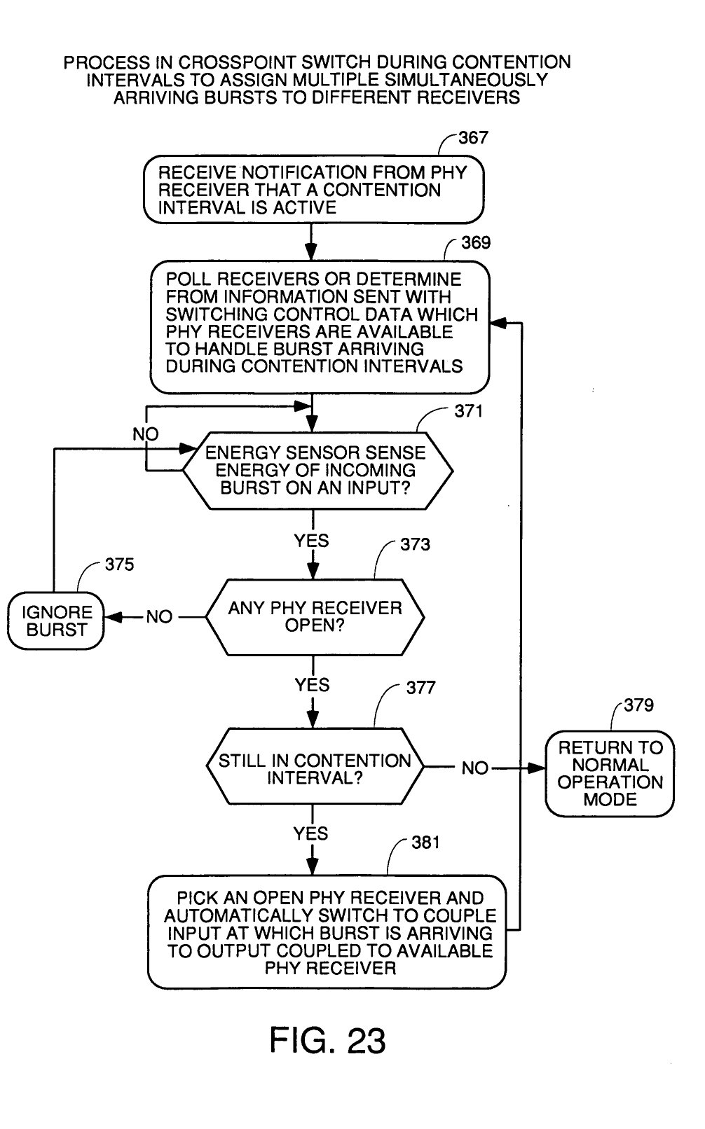

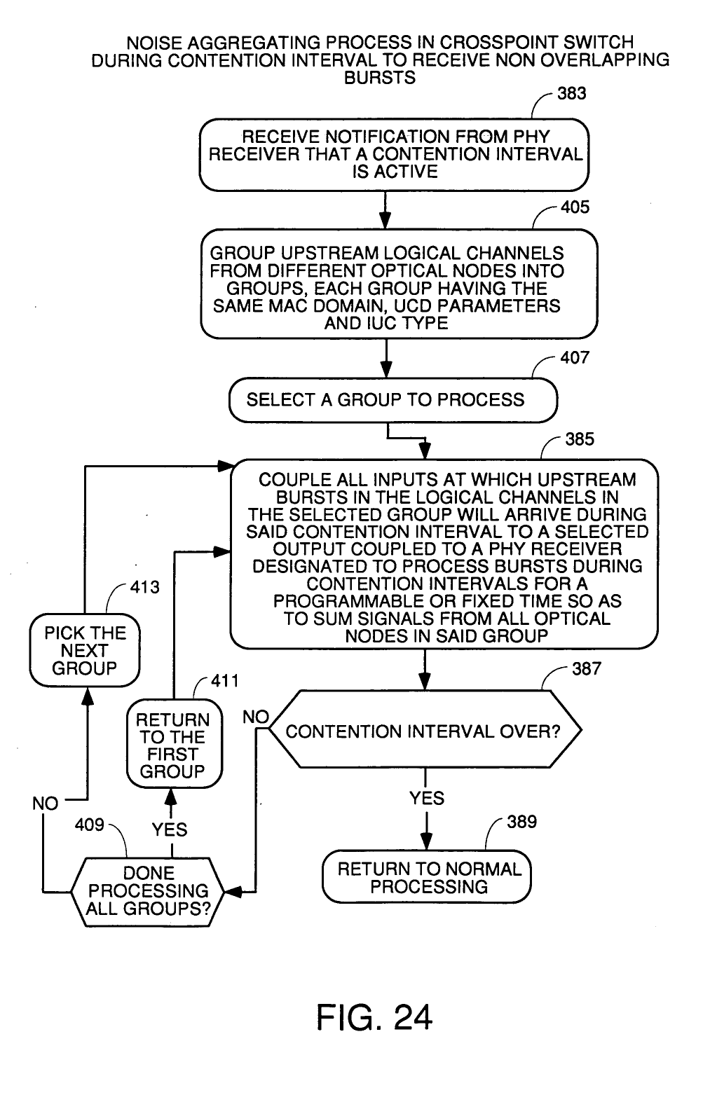

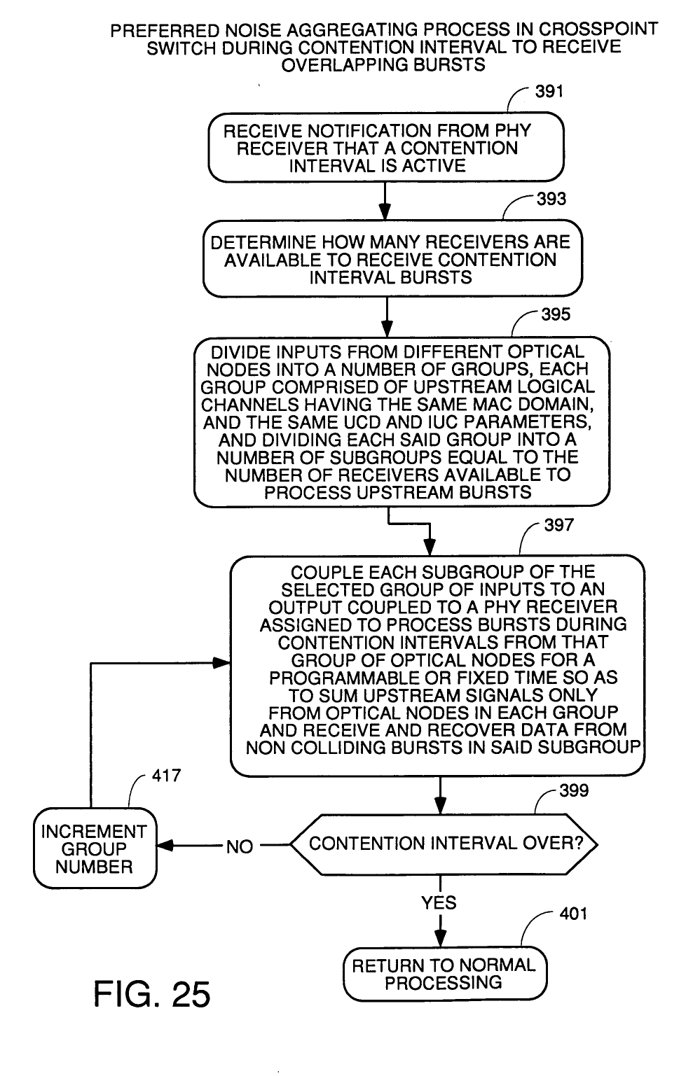

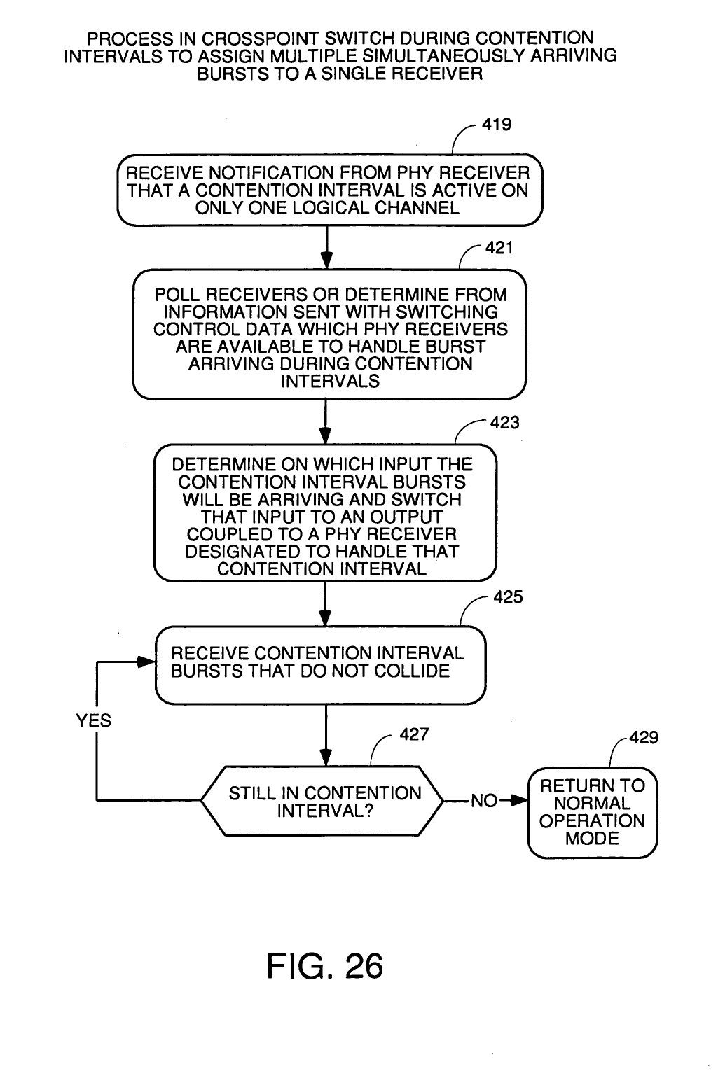

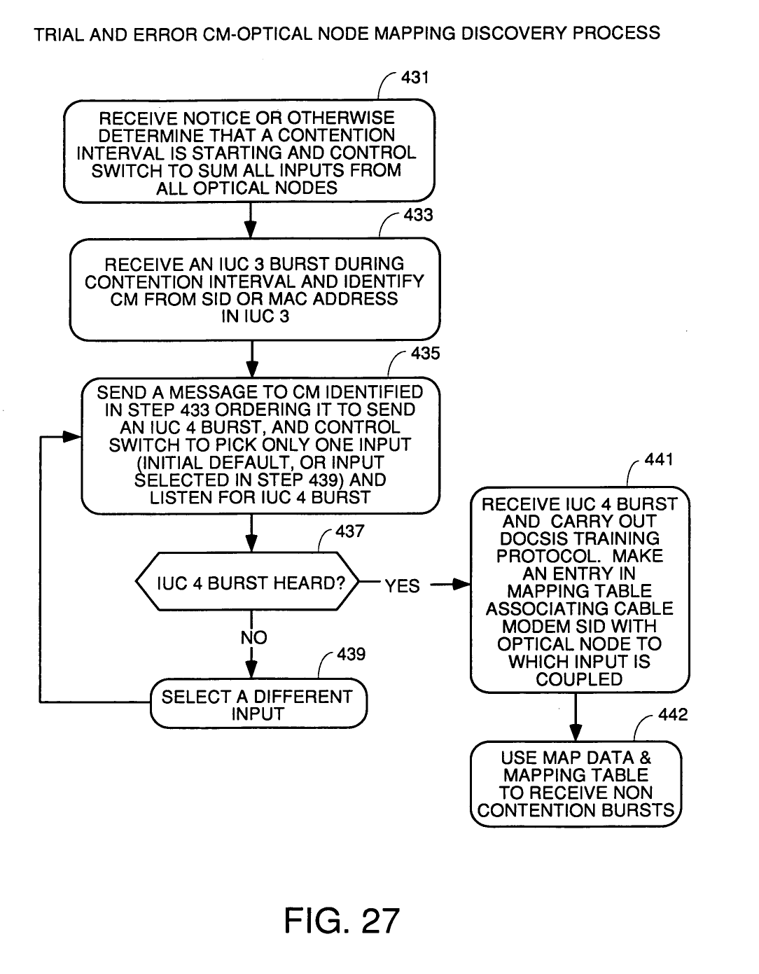

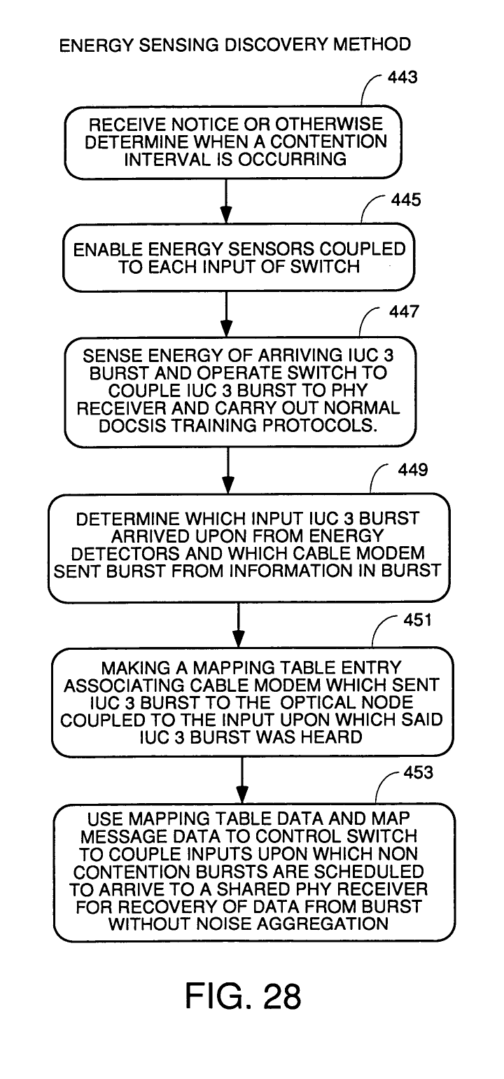

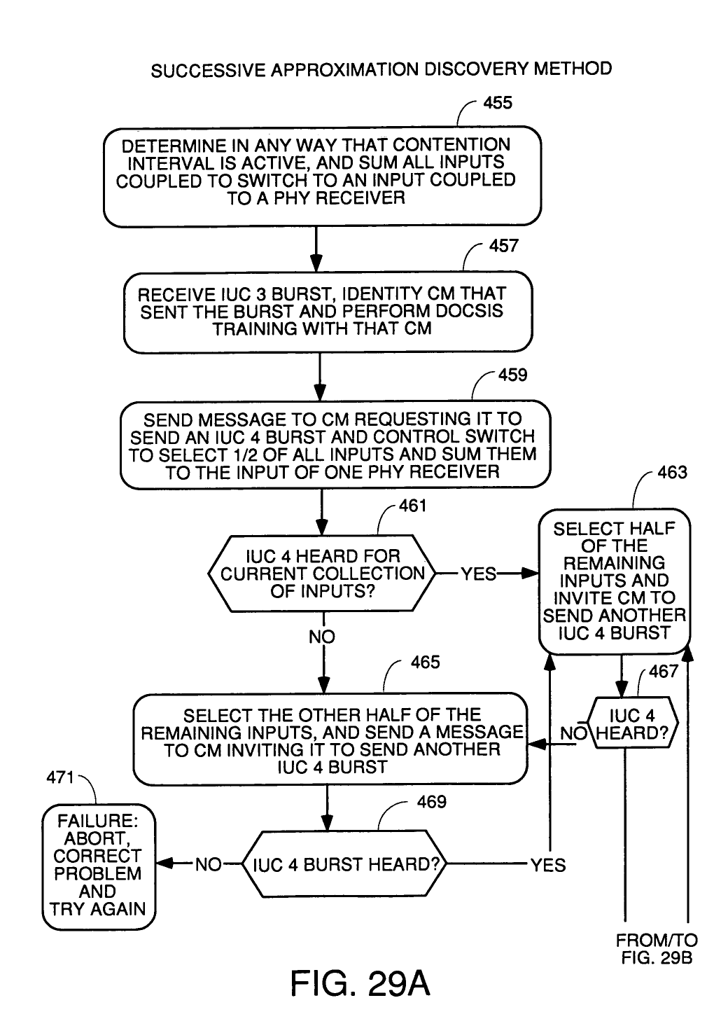

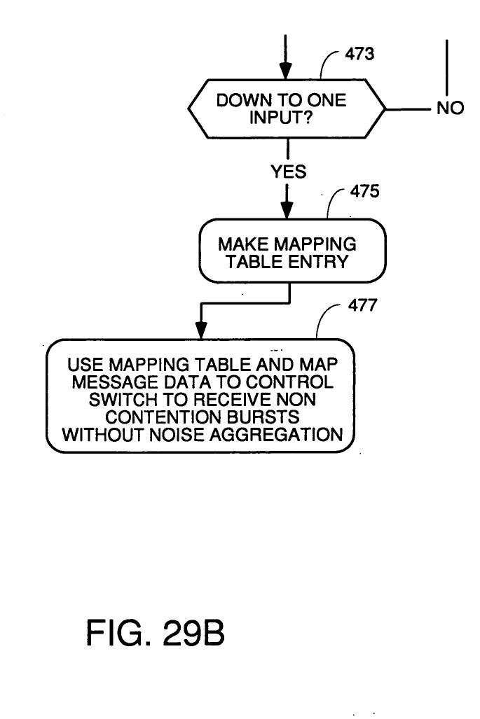

The temperature and pressure conditions are selectively controlled within the buffer tank to selectively maintain the carbon dioxide within the tank to be in a gas, liquid or supercritical state. In addition, depending upon the types and concentrations of additives (e.g., co-solvents) that are provided in the carbon dioxide, some separation of additives from carbon dioxide may occur within the buffer tank. The buffer tank may be provided with a drain valve to remove such additives as desired. An exemplary buffer section that includes a buffer tank with a drain valve and that can be implemented for use in the system of FIG. 1 is described in detail in the embodiment of FIG. 3 described below.

A second purification section 50 is disposed downstream from the buffer section 42 to facilitate removal of contaminants from and purification of the carbon dioxide effluent stream. The second purification section includes one or more suitable purification units to process the carbon dioxide effluent that exits the process chamber. The second purification section can include any suitable number, combination and/or types of purification units such as those described above for the first purification section including, without limitation, adsorption units, absorber units, distillation units, filtration units (e.g., one or more filters with selected mesh sizes), catalytic oxidation units, and mechanical separators (e.g., cyclonic separators).

In the embodiment of FIG. 1, the second purification section 50 includes a scrubber unit 52, a mechanical separation unit 54 disposed downstream from the scrubber unit 52, a filtration unit 56 disposed downstream from the separation unit 54, and an auxiliary purification unit 60 disposed downstream from the filtration unit 54. The scrubber unit 52 removes acids (e.g., hydrofluoric acid) and other hazardous compounds from the carbon dioxide effluent stream. It is particularly important to remove these compounds as soon as possible to prevent corrosion or degradation of additional purification units or other system components further downstream from the process chamber. Preferably, the scrubber unit includes a solid phase adsorbent material such as soda lime or soda asbestos. Alternatively, a liquid phase scrubber may be utilized alone or in combination with the solid phase adsorbent material. Exemplary pressure and temperature ranges for the carbon dioxide effluent stream in the scrubber unit are the same as described above for the buffer unit.

The mechanical separation unit 54 disposed downstream from the scrubber unit 52 can include any one or combination of a cyclone separator, an impingement separator, a gravity separator, a centrifuge and/or any other suitable separation device to separate and recover co-solvent liquids and contaminant solids such as photoresist and other materials from the carbon dioxide effluent stream. The carbon dioxide is maintained at supercritical or liquid state while being processed within the separation unit 54. Exemplary pressures of the carbon dioxide effluent stream within the separation unit 54 are in the range of about 1100 psig (75.84 bar) to about 4000 psig (275.8 bar), preferably about 1100 psig (75.84 bar) to about 1800 psig (124.1 bar), while exemplary temperatures of the stream within the separation unit 54 are in the range of about 0° C. to about 70° C. A separation stream 55 connects at the bottom of the separation unit 54 and delivers separated material from the separation unit to a waste tank or processing facility for further purification or disposal of the material. Optionally, the separation stream 55 can include a control valve and/or one or more sensors (e.g., liquid level sensors) and a controller to facilitate automatic and periodic draining of the separation unit 54 when a sufficient amount of liquid separates from the carbon dioxide stream within the separation unit.

As an alternative, or in addition to, the separation unit 54, additional solid and/or liquid separator units may also be provided in-line at a suitable location downstream from the scrubber unit 52. For example, multiple solid and/or liquid separator units may be placed in series and/or in parallel in the second purification section. Further, the temperature and pressure conditions within a particular separation unit can be selectively controlled to maintain both supercritical and liquid states for the effluent within the separation unit, where carbon dioxide is maintained in supercritical state while one or more co-solvents are maintained in liquid state. This will allow the liquid co-solvents, which collect at the lower end of the vessel, to be separated and removed from the unit in a waste stream. In another example, the entire effluent can be maintained in liquid state in, e.g., a gravity separator, where the co-solvents having higher densities than liquid carbon dioxide will be separated and removed near the bottom of the separator. Alternatively, if the liquid carbon dioxide has a higher density than certain additives, the separation can be achieved by removing the liquid carbon dioxide from the bottom of the separation unit.

The filtration unit 56 includes one or more filters of selected mesh sizes to remove solids and particles of selected sizes from the carbon dioxide effluent stream at a location downstream from the separation unit 54. The filtration unit 56 can further be temperature controlled (e.g., cooled) to solidify certain contaminants for collection by the filters.

A conditioner unit 58 is disposed in-line between the filtration unit 56 and the auxiliary purification unit 60. The conditioner unit 58 adjusts the temperature and pressure of the effluent stream to suitable levels as necessary to ensure the carbon dioxide is in supercritical or liquid state prior to delivery to the auxiliary purification unit. The conditioner unit can include any one or combination of a valve, a pump, a condenser, a heat exchanger (e.g., electrical heater), or any other suitable device to increase or decrease the pressure and/or temperature accordingly to achieve the desired state for carbon dioxide prior to entering the auxiliary purification unit 60.

The auxiliary purification unit 60 can be any one or combination of additional purification units provided to remove additional contaminants from the carbon dioxide as needed for a particular application. For example, the unit 60 can include a supercritical or liquid state adsorption unit to perform pressure swing adsorption (PSA), vacuum swing adsorption (VSA), thermal swing adsorption and/or any other suitable adsorption techniques. Multiple PSA units can be provided in series to remove contaminants from carbon dioxide. In another embodiment, combinations of PSA and thermal swing adsorption units can be provided (e.g., PSA followed by thermal swing adsorption). Alternatively, the unit 60 can include a supercritical oxidation unit to oxidize certain remaining contaminants (e.g., photoresist) that remain in the carbon dioxide effluent. Further still, the auxiliary purification unit can include a distillation column that removes contaminants from liquid carbon dioxide effluent. Exemplary pressures and temperatures for the carbon dioxide effluent stream within the auxiliary purification unit are the same as those described above for the mechanical separation unit.

A recycle line 62 is provided to direct the purified carbon dioxide effluent emerging from the second purification section 50 to be combined with carbon dioxide fed from the feed source 10 at a location upstream from the pressurization unit 12. A conditioner unit 64 is provided in-line along the recycle line 62 to selectively adjust the temperature and pressure of the effluent stream to suitable levels prior to combining with the carbon dioxide feed stream. The conditioner unit can include any one or combination of a valve, a pump, a condenser, a heat exchanger (e.g., electrical heater), or any other suitable device to increase or decrease the pressure and/or temperature accordingly of the carbon dioxide effluent stream prior to being combined with carbon dioxide from the feed source.

Optionally, a bypass line 70 is provided to direct carbon dioxide effluent exiting from the process chamber 40 back to the first purification section 20, thus bypassing the second purification system altogether. This feature may be useful in situations where the first purification section is suitably sized and configured to effectively separate contaminants and additives from and purify the carbon dioxide effluent together with carbon dioxide supplied from the source. The bypass line 70 includes valves 72 and 74 disposed near the upstream and downstream ends of the bypass line. In addition, a valve 73 disposed in-line at a suitable location downstream from the bypass line and upstream from the second purification section. The valves 72-74 are selectively adjusted to control the flow of carbon dioxide effluent through the bypass line in situations where the second purification system is not needed or is brought offline for maintenance. Alternatively, and depending upon the pressure of the carbon dioxide effluent exiting the process chamber 40, the bypass line 70 can direct the effluent stream directly into the pressurization unit 12 prior to delivery to the first purification section 20.

In addition, an optional vent line 80 is provided at an outlet location from the separator unit 54 of the second purification section 50, or at any other suitable location, to selectively vent purified carbon dioxide from the system at any time during system operation (e.g., via selective adjustment of the valve 82 on vent line 80).

In operation, carbon dioxide flows from the supply source 10 in a liquid state to the pressurization unit, where it is pressurized to a suitable pressure above the critical point for carbon dioxide. The pressurized carbon dioxide is purified in the first purification section by adsorption in the adsorption unit 22 in the liquid state, followed by catalytic oxidation in the oxidation unit 24 in the liquid state or supercritical state. Oxygen is delivered in controlled amounts from the supply source 26 to the oxidation unit 24. The purified carbon dioxide stream is then passed through the oxygen destruct unit 32 to remove excess oxygen from the stream, and then through the heat exchanger 33 to heat the stream to above the critical temperature for carbon dioxide, thus ensuring the carbon dioxide feed stream is in a supercritical state upon entering the process chamber 40.

The carbon dioxide is utilized in the process chamber for cleaning and/or other processing applications. Carbon dioxide effluent emerging from the process chamber 40 is directed to the buffer section 42, where the temperature and pressure of the effluent are stabilized in the manner described above prior to being directed to the second purification section 50. The carbon dioxide effluent is purified to remove additives and contaminants from the carbon dioxide in the scrubber unit 52, the mechanical separation unit 54, the filtration unit 56 and one or more auxiliary purification units (described generally by unit 60). The carbon dioxide is preferably maintained in liquid or supercritical state throughout the purification steps in the second purification section 50. The purified carbon dioxide effluent is then recycled back to the first purification section 20 via the recycle line 62, and make-up or fresh carbon dioxide is combined with the effluent as needed from the supply source 10.

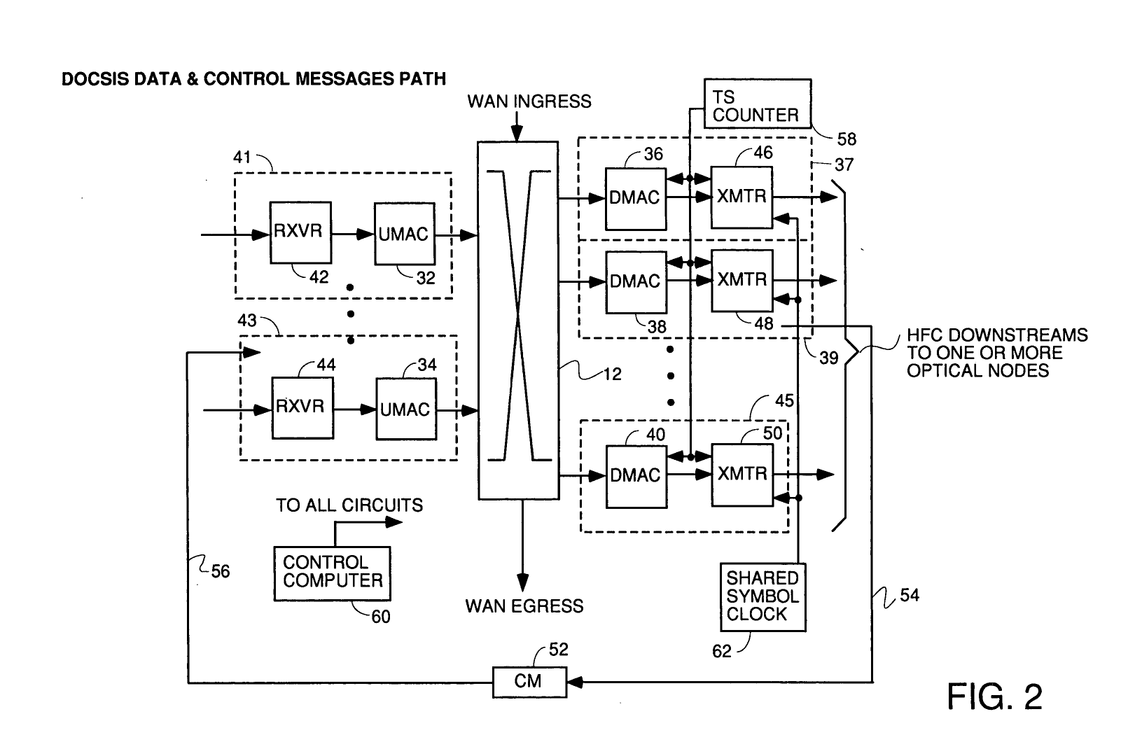

The system described above preferably maintains the carbon dioxide in liquid or supercritical state throughout all processing stages, thus reducing energy and equipment costs associated with re-pressurizing carbon dioxide effluent to supercritical pressures. In addition, the system described above can be readily modified to facilitate simultaneous supply of multiple process chambers with carbon dioxide. The process chambers can perform the same or different functions. Referring to FIG. 2, the system 2 described above is modified to include a series of chambers 40-1, 40-2, 40-3 and 40-4 oriented in parallel with each other, with the carbon dioxide feed stream being delivered via a manifold piping system to the inlets of each chamber. The outlets of the chambers are combined into a single flow line, via a manifold piping system, and are then directed to the buffer section 42. Alternatively, the system may include two or more buffer sections to process outlet streams from different chambers. In addition, additives can be added via a single line 34 located upstream from the manifold piping (as depicted in FIG. 2) or, alternatively, via individual lines associated with each process chamber. Thus, the system of FIG. 2 permits multiple process chambers to be supplied by a single carbon dioxide supply, purification and recovery arrangement.

The system of FIG. 2 can be modified and the conditions within the buffer tank can be controlled such that the buffer tank maintains dual states (e.g., liquid and supercritical or gas), where the buffer tank includes two exit streams drawn from the top and bottom locations of the tank and each stream is directed to one or more purification units for processing.

In another embodiment, a carbon dioxide purification and recovery system is depicted including a buffer section with temperature, pressure and flow control features that achieve steady state conditions for the carbon dioxide effluent prior to transport to a purification section. As noted above, the buffer section is an important feature in the system. For example, during a typical semiconductor cleaning operations with supercritical carbon dioxide, the pressure of the carbon dioxide is cycled within the chamber to enhance mixing such that variations in pressure of the carbon dioxide stream can occur by as much as 10-50% from the mean pressure. These pressure fluctuations can be detrimental to the operation of certain purification units.

The buffer section of the present invention stabilizes the pressure, temperature and flow rate of the carbon dioxide effluent that exits the process chamber and maintains the carbon dioxide in at least one of gas, liquid and supercritical states, so that the effluent can be processed in a suitable and effective manner in the purification section disposed downstream from the process chamber. The buffer section is further capable of converting the carbon dioxide effluent to any selected one or more states that may differ from the state of the effluent exiting the process chamber. For example, supercritical carbon dioxide effluent exiting the process chamber can be converted by the buffer section to liquid and/or gaseous carbon dioxide effluent. Preferably, the buffer section delivers the effluent stream to one or more purification units of a purification section at a pressure that fluctuates by no more than about 10% of a mean or preselected pressure value, more preferably no more than about 5% of a mean or preselected pressure value, and most preferably no more than about 1% of a mean or preselected pressure value.

An exemplary embodiment of a buffer section combined with a carbon dioxide purification and recovery system is depicted in FIG. 3. In particular, the system 100 includes a buffer section 110 disposed downstream from a process chamber 102, and a purification section 140 disposed downstream from the buffer section 110. The purification section 140 includes one or more purification units that process and purify the carbon dioxide effluent in a gas state, liquid state and/or supercritical state.

The buffer section 110 includes a pressure sensor 112 disposed in-line and downstream from the process chamber 102 to measure the pressure of the effluent stream emerging from the chamber. The system piping branches into two sections 113 and 114 at a location downstream from the pressure sensor 112, where the first pipe section 113 connects to a buffer tank 120 and the second pipe section 114 connects to a purification unit in the purification section 140 as described below. A first control valve 115 is disposed in the first pipe section 113, while a second control valve 116 is disposed in the second pipe section 114. A controller 118 communicates (e.g., via electrical wiring and/or wireless communication) with the pressure sensor 112 and each control valve 115, 116 so as to effect independent manipulation of the control valves in response to measured pressures of the carbon dioxide effluent as described below.

The buffer tank 120 is configured to receive and store carbon dioxide effluent prior to the effluent being delivered to the purification section 140. The dimensions and capacity of the buffer tank will vary depending upon the carbon dioxide flow requirements. The buffer tank 120 is temperature controlled (e.g., by providing a heat exchanger within the tank and/or a heat control jacket around the buffer tank) to heat and/or cool the effluent disposed within the tank. Preferably, the temperature of the effluent within the buffer tank is maintained within a range of about 0° C. and about 70° C., while the pressure of the effluent within the buffer tank is preferably maintained within a range of about 500 psig (34.47 bar) to about 4000 psig (275.8 bar), more preferably in a range of about 1000 psig (68.95 bar) to about 2500 psig (172.4 bar). Alternatively, as noted above, any one or combination of devices could be utilized within the buffer section to maintain the temperature and pressure of the carbon dioxide effluent at suitable levels including, without limitation, a vessel or tank, a pipe section with suitable internal dimensions to selectively adjust the pressure of the effluent stream, a pulse dampener, one or more valves and/or pressure regulators, etc.

The carbon dioxide effluent can be maintained in any one or more states (i.e., gas, liquid and/or supercritical) within the buffer tank 120. Depending upon the types and concentrations of co-solvents that exist in the effluent and also the temperature and pressure conditions within the buffer tank, it is possible to achieve some degree of separation of co-solvents from carbon dioxide within the tank. As noted above, many co-solvents have greater densities than carbon dioxide and will separate to the bottom of the buffer tank. To the extent any separation is achieved, the liquid co-solvents and any contaminants entrained therein can be removed from the buffer tank 120 via a drain line 121 connected between the buffer tank 120 and a collection vessel 122.

A liquid level controller 124 communicates (via electrical wiring and/or wireless communication) with a liquid level sensor disposed at a suitable location within the buffer tank 120 and a control valve 125 disposed along the drain line 121. When the liquid level sensor detects the liquid level within the buffer tank has exceeded a threshold level, the controller 124 effects opening of the valve 125 to permit liquid to drain from the tank 120 and be delivered to the collection vessel 122. The liquid in the collection vessel can be further processed in any suitable manner in a recovery system to recover co-solvents for re-use during system operation. If the co-solvent recovery system is located a considerable distance from the collection vessel 122, a pump or purge gas line (e.g., utilizing nitrogen, carbon dioxide, helium and/or other inert gases) can be implemented to transport the liquid from the collection vessel at suitable flow rates.

An effluent delivery line 130 connects the outlet of the buffer tank 120 with a primary purification unit 142 of the purification section 140. Disposed along the effluent delivery line 130 are a pressure sensor 132, a control valve 134 located downstream from the pressure sensor 132, and a pressure regulator 136 disposed downstream from the control valve 134. A controller 138 communicates (e.g., via electrical wiring and/or wireless communication) with the pressure sensor 132 and the control valve 134 to effect manipulation of the control valve based upon measurements of the effluent pressure by the pressure sensor as described below. The pressure regulator 136 ensures the carbon dioxide effluent transferred from the buffer tank 120 to the primary purification unit 142 is at a suitable pressure that fluctuates by no more than about 10% of a mean or preselected pressure value, preferably no more than about 5% of a mean or preselected pressure value. Most preferably, the pressure regulator ensures the carbon dioxide effluent is at a substantially constant pressure (e.g., with variance from a mean or preselected pressure value of no more than about 1%) when the effluent enters the primary purification unit. Alternatively, it is noted that one or more pressure sensors can be disposed at any suitable locations upstream, downstream and/or within the buffer tank to provide an indication as to the pressure of the effluent stream within or near the buffer tank.

The purification section 140 can include any one or more purification units arranged in series or in parallel such as those described above for system of FIG. 1. In an exemplary embodiment, the primary purification unit 142 includes a mechanical separator (e.g., a cyclone separator) to remove additives (e.g., co-solvents) and contaminants from carbon dioxide. The separator is operated to maintain at least two phases, where one phase is a carbon dioxide enriched gas, liquid or supercritical state, and another phase is an additive enriched liquid state including solid and/or liquid contaminants.

An exemplary operating pressure range for the carbon dioxide effluent stream in the mechanical separator is in the range of about 10 psig (0.69 bar) to about 2500 psig (172.4 bar), preferably in a range of about 80 psig (5.52 bar) to about 1200 psig (82.74 bar). Exemplary temperatures of the effluent within the primary purification unit are in the range of about −60° C. to about 80° C. Any suitable heat control device can be employed to maintain such temperatures within the unit. Heavy liquids are separated within the primary purification unit 142 and are removed via a drain line 143 to be transported to a collection vessel (not shown). A liquid level controller 144 communicates (via electrical wiring and/or wireless communication) with a liquid level sensor disposed at a suitable location within the primary purification unit 142 and a control valve 146 disposed along the drain line 143. When the liquid level sensor detects the liquid level within the primary purification unit has exceeded a threshold level, the controller 144 effects opening of the valve 146 to permit liquid to drain from the unit 142 in order to be transported to the collection vessel. Optionally, a pump or purge gas line can be provided to transport liquids drained from the primary purification unit to the collection vessel and/or any other processing location.

The flow and pressure of the carbon dioxide effluent into the primary purification unit 142 is at least partially controlled by the controller 138 (through operation of valve 134) and pressure regulator 136 of the buffer section 110. However, additional flow control into and through the primary purification unit 142 can be implemented via one or more flow control devices disposed at upstream and/or downstream locations of the unit 142. For example, devices such as a metering valve, an orifice, or any suitable type of mass flow controller (e.g., thermal, coriolis, etc.) can be provided at a suitable downstream location from the unit 142. Alternatively, one or more such flow control devices can be provided at suitable upstream locations from the unit 142, while a back-pressure regulator is provided at a suitable downstream location from the unit 142. Any suitable one or combination of such devices ensures the pressure and flow rate of the effluent stream within the unit 142 are maintained at suitable and relatively constant values. In particular, the flow rate of the effluent can be maintained such that it fluctuates by no more than about 10% of an average or preselected flow rate value, preferably no more than about 5% of an average or preselected flow rate value, and most preferably no more than about 1% of an average or preselected flow rate value.

An exemplary flow control design for the primary purification unit 142 is depicted in FIG. 3 and includes a pressure sensor 150 disposed in-line at a downstream location from the unit 142, a control valve 152 disposed in-line at a downstream location from the pressure sensor 150, and a controller 154 in communication (e.g., via electrical wiring and/or wireless communication) with each of the valve 152 and the sensor 150. A second purification unit 160 is disposed in-line at a downstream location from the valve 152. The controller 154 effects manipulation of the valve 152 to control the flow of effluent through the primary purification unit 142 as well as to the second purification unit 160 based upon measured pressure information from the sensor 150.

The second purification unit 160 can be any one or more suitable purification devices such as those described above for the embodiment of FIG. 1. In an exemplary embodiment, the unit 160 is one of an adsorber unit, an impingement device, a filter, a scrubber or a coalescer. The second purification unit operates at a lower pressure than the primary purification unit (e.g., in a range of about 14 psig or 1 bar to about 250 psig or 17.24 bar) and further separates additives and contaminants from carbon dioxide. The temperature conditions for the second purification unit 160 are similar to those described above for the primary purification unit 142, and any suitable heat control device can be employed to maintain the desired temperature within the second purification unit. The second purification unit 160 includes an inlet to receive carbon dioxide effluent from the primary purification unit 142 and also directly from the process chamber 102 via pipe line 114. As described in greater detail below, this feature permits the flow of carbon dioxide effluent to bypass the primary purification unit, being transported directly to the second purification unit.

Liquids are separated within the second purification unit 160 and are removed via a drain line 161 to be transported to a collection vessel (not shown). A liquid level controller 162 communicates (via electrical wiring and/or wireless communication) with a liquid level sensor disposed at a suitable location within the second purification unit 160 and a control valve 164 disposed along the drain line 161. When the liquid level sensor detects the liquid level within the primary purification unit has exceeded a threshold level, the controller 144 effects opening of the valve 146 to permit liquid to drain from the unit 142 and be transported to the collection vessel. Optionally, a pump or purge gas line can be provided to transport liquids drained from the second purification unit to the collection vessel and/or any other processing location. The outlet line 165 of unit 160 includes substantially purified carbon dioxide (e.g., containing less than 1% volume of additives and/or contaminants).

In operation, carbon dioxide effluent containing additives and contaminants is delivered from the outlet of the process chamber 102 into one of the branched pipe lines 113 or 114, depending upon the pressure of the effluent as measured by the pressure sensor 112. In particular, the controller 118 effects manipulation of valve 115 to an open position and valve 116 to a closed position to facilitate flow of effluent to the buffer tank 120 when the pressure is at or above a threshold value or range of values (e.g., in the range of about 400 psig (27.58 bar) to about 5000 psig (344.7 bar), preferably in a range of about 1000 psig (68.95 bar) and 3000 psig (206.8 bar)). When the pressure is below the threshold value or range of values (e.g., during a de-pressurization step when the process chamber is to be evacuated or at any other time when the pressure drops to below an acceptable value), the controller effects manipulation of valve 115 to a closed position and valve 116 to an open position to permit the effluent stream to bypass the buffer tank 120 and primary purification unit 142 so as to be transported directly to the second purification unit 160. This allows the buffer tank to maintain carbon dioxide effluent within acceptable steady state pressure and temperature values for being delivered to the primary purification unit independent of significant decreases in pressure at the process chamber 102. Alternatively, it is noted that a timer signal representing processing time for a particular operation can also be sent to the controller 118 to achieve appropriate manipulation of the valves 115 and 116 at certain processing times.

When the valve 115 is open, carbon dioxide effluent is directed into the buffer tank 120. During initial system operation, the valve 134 is maintained in a closed position by the controller 138 to permit the buffer tank 120 to be filled to a pre-determined pressure as measured by pressure sensor 132 (preferably in a range of about 500 psig (34.47 bar) to about 4000 psig (275.8 bar), more preferably in a range of about 1000 psig (68.95 bar) to about 2500 psig (172.4 bar). In addition, the temperature of the effluent is maintained within a selected range (e.g., about about 0° C. and about 70° C.) by the temperature control device associated with the buffer tank. Separation and removal of co-solvent liquid from carbon dioxide (in gas, liquid or supercritical state) is achieved as described above via the drain line 121, valve 125, and liquid level controller 124.

When the pressure measured by the pressure sensor 132 reaches a threshold value or range of values (e.g., see the pressure values noted above for the buffer tank), the controller 138 effects manipulation of the valve 134 to an open position to permit carbon dioxide effluent to flow from the buffer tank 120 to the primary purification unit 142. Similarly, when the pressure measured by the pressure sensor 132 drops below the threshold value or range of values, the valve 134 is closed.

The pressure regulator 136 ensures that carbon dioxide fluid is delivered to the unit 142 at a substantially constant pressure. Heavy liquids including additives (e.g., co-solvents) and/or contaminants are separated from the carbon dioxide in the primary purification unit 142, and the purified carbon dioxide stream exits the primary purification unit and is delivered to the secondary purification unit 160. The flow controller 154 controls the flow of effluent through the primary separation unit 142 and into the second purification unit 160 by monitoring the pressure of the fluid via pressure sensor 150 and effecting manipulation of the control valve 152 accordingly.

Purified carbon dioxide effluent that exits the primary purification unit 142 is further purified in the second purification unit. Alternatively, when valve 115 is closed and valve 116 is opened, carbon dioxide effluent is transported directly from the process chamber 102 to the second purification unit 160. Optionally, the controller 138 for the primary purification unit 142 is in communication with the controller 118 of the valves 115 and 116, such that the controller 138 effects a closing of valve 134 upon opening of valve 116 to prevent the flow of an effluent stream from the primary purification unit to the second purification unit 160 when effluent is being sent directly from the process chamber 102 to the second purification unit. Purified carbon dioxide exits the second purification unit 160 in the outlet line 165 at a desired purified level (e.g., containing less than 1% by volume of additives and/or contaminants). The purified carbon dioxide can be recycled back for use in the process chamber 102 (e.g., in a similar manner as described above for the system of FIG. 1), utilized in other processes, and/or completely or partially vented to the surrounding environment.

The system described above and depicted in FIG. 3 can be modified so as to include a single controller rather than multiple controllers to perform the various automated valve control operations as described above. In addition, the system can be modified to include any suitable number, combination and/or types of purification units, depending upon the level of purification desired and/or types of additives and contaminants that are to be removed from the carbon dioxide effluent for a particular application. Further, additional sensors and/or controllers can be implemented in-line at various locations within, upstream and/or downstream from one or more purification units to determine the amount of one or more additives or contaminants that remain in the carbon dioxide stream as well as temperature and pressure conditions of the effluent stream at certain locations and other conditions (e.g., liquid level) within certain units.

Bypass piping networks including control valves can be implemented at any one or more suitable locations between any two or more purification units to permit the system to selectively bypass one or more purification units during system operation depending upon the measured purity level of the carbon dioxide effluent at a particular location in the purification section. Thus, the system can be designed to selectively alter the flow path of effluent streams through the purification section during system operation based upon measured parameters and/or to when certain purification units are brought offline (e.g., for maintenance or repair).

In addition, bypass piping networks can also be provided upstream of the buffer tank or buffer section. For example, referring to the system of FIG. 1, a bypass line can be provided at a location upstream of the buffer section 42. The bypass line can be utilized to bypass the buffer section for delivering the carbon dioxide effluent stream directly to a purification unit (e.g., similar to line 114 in the system of FIG. 3) or, alternatively, to deliver the effluent stream to another location and/or vent the stream to the surrounding environment.

In addition to providing one or more flow controllers (e.g., flow-limiting orifices and/or pressure regulators and controllers) at various locations between the buffer tank and/or one or more purification units, the buffer tank and/or purification units can be sized accordingly based upon average flow rates of carbon dioxide effluent that are expected for certain applications. For example, the primary purification unit 142 of FIG. 3 can be sufficiently sized to accommodate an average flow of effluent that is expected, and the buffer tank 120 can be sufficiently sized to accommodate flow fluctuations so as to ensure the effluent is delivered at or within a suitable range of the average flow rate value.

The systems described above are not limited to use with semiconductor process chambers. Rather, the systems can be implemented for use with any number of different process stations in which carbon dioxide or other fluids are utilized for cleaning or any other process, where the fluids can be provided to the process station in gas, liquid or supercritical state.

Having described novel systems and method for purification and recovery of fluids in processing applications, it is believed that other modifications, variations and changes will be suggested to those skilled in the art in view of the teachings set forth herein. It is therefore to be understood that all such variations, modifications and changes are believed to fall within the scope of the present invention as defined by the appended claims.

1. A fluid purification and recovery system comprising:
a buffer section configured to receive a fluid delivered from a process station, wherein the fluid pressure is maintained within the buffer section within a predetermined range and the fluid is maintained within the buffer section in at least one of a gas state, a liquid state and a supercritical state; and
a purification section disposed downstream from the buffer section to receive the fluid from the buffer section and including at least one purification unit that separates at least a portion of at least one component from the fluid.

2. The system of claim 1, wherein the fluid is maintained within the buffer section and the purification section in at least one of a liquid state and a supercritical state.

3. The system of claim 1, further comprising:
a fluid supply source to deliver the supercritical fluid to the process station.

4. The system of claim 3, wherein the fluid supply source delivers a fluid comprising carbon dioxide to the process station.

5. The system of claim 4, further comprising an additive supply source disposed downstream from the fluid supply source to inject at least one additive into at least one of the fluid prior to delivery to the process station and the process station.

6. The system of claim 5, wherein the at least one additive is selected from the group consisting of alcohols, halogenated hydrocarbons, saturated hydrocarbons, unsaturated hydrocarbons, aromatic hydrocarbons, amines, aldehydes, anhydrides, organic acids, inorganic acids, ketones, esters, glycols, fluoride containing materials and combinations thereof.

7. The system of claim 6, wherein the at least one purification unit is configured to separate at least one additive from the fluid.

8. The system of claim 1, wherein the buffer section comprises a buffer tank, a pressure sensor to measure fluid pressure at a location within or proximate the buffer tank, a valve disposed downstream from the buffer tank, and a controller in communication with the pressure sensor and the valve, wherein the controller effects manipulation of the valve to open and closed positions based upon pressure measurements determined by the sensor.

9. The system of claim 8, further comprising:
a pressure regulator disposed between the buffer tank and the purification unit.

10. The system of claim 1, wherein the buffer section delivers fluid to at least one purification unit of the purification section at a pressure that fluctuates no more than about 10% from a preselected pressure value.

11. The system of claim 1, further comprising:
a second purification section disposed downstream from and separately and independently connectable to each of the process station and the purification section to facilitate receiving a first fluid stream from the purification section and a second fluid stream from the process station, the second purification section including at least one purification unit.

12. The system of claim 11, further comprising:
a controller to selectively alternate fluid flow from the process station to the buffer tank and the second purification section.

13. The system of claim 12, further comprising:
a pressure sensor disposed at a location downstream from the process station;
a first valve disposed along and in fluid communication with a first fluid supply line that is configured to connect the process station with the buffer tank; and
a second valve disposed along and in fluid communication with a second supply line that is configured to deliver the second fluid stream from the process station to the second purification section;
wherein the controller is in communication with the pressure sensor and the first and second valves to alternate opening of the first and second valves based upon pressure measurements determined by the pressure sensor.

14. The system of claim 1, wherein the at least one purification unit comprises at least one of an adsorption unit, an oxidation unit, a distillation unit, an absorber unit, a filter, a coalescer and a mechanical separation unit.

15. The system of claim 1, further comprising:
a recycle line configured to receive fluid purified by the purification section and deliver the purified fluid to the process station.

16. The system of claim 1, wherein the buffer section is configured to receive fluids delivered from a plurality of process stations.

17. A fluid purification and recovery system comprising:
a fluid supply source connectable at an upstream location with a process station to provide fluid to the process station; and
a purification section including at least two purification units located at a downstream location from and connectable with the process station to receive fluid exiting the process station;
wherein the purification units of the purification section remove at least one component from the fluid while the fluid is maintained in at least one of a supercritical state and a liquid state.

18. The system of claim 17, wherein each purification unit comprises at least one of an adsorption unit, an oxidation unit, a distillation unit, an absorber unit, a filter, a coalescer and a mechanical separation unit.

19. A method of purifying a fluid for use at a process station comprising:
facilitating the delivery of fluid from the process station to a buffer section;
maintaining the fluid pressure within the buffer section within a predetermined range and further maintaining the fluid within the buffer section in at least one of a gas state, a liquid state and a supercritical state;
facilitating the delivery of fluid from the buffer section to a purification section including at least one purification unit; and
separating at least a portion of at least one component from the fluid in the at least one purification unit of the purification section.

20. The method of claim 19, wherein the fluid is maintained within the buffer section and the purification section in at least one of a liquid state and a supercritical state.

21. The method of claim 19, further comprising:
facilitating the delivery of supercritical fluid from a supply source to the process station.

22. The method of claim 21, wherein the fluid comprises carbon dioxide.

23. The method of claim 22, wherein the process station comprises a semiconductor fabrication chamber, and the fluid is delivered to the chamber to facilitate cleaning and removal of one or more components from semiconductor substrates disposed in the chamber.

24. The method of claim 23, wherein the process station includes a plurality of semiconductor fabrication chambers.

25. The method of claim 21, further comprising:
injecting at least one additive from an additive supply source to at least one of the fluid prior to delivery to the process station and the process station

26. The method of claim 25, wherein the at least one additive is selected from the group consisting of alcohols, halogenated hydrocarbons, saturated hydrocarbons, unsaturated hydrocarbons, aromatic hydrocarbons, amines, aldehydes, anhydrides, organic acids, inorganic acids, ketones, esters, glycols, fluoride containing materials and combinations thereof.

27. The method of claim 25, wherein the at least one purification unit is configured to separate at least one additive from the fluid.

28. The method of claim 19, wherein the buffer section includes a buffer tank, a pressure sensor disposed at a location within or proximate the buffer tank, a valve disposed downstream from the buffer tank, and a controller in communication with the pressure sensor and the valve, and the method further comprises:
automatically opening and closing the valve, via the controller, based upon pressure measurements determined by the pressure sensor.

29. The method of claim 28, wherein the buffer section further includes a pressure regulator disposed between the buffer tank and the purification unit.

30. The method of claim 19, wherein the buffer section delivers fluid to at least one purification unit of the purification section at a pressure that fluctuates no more than about 10% from a preselected pressure value.

31. The method of claim 30, wherein the process station comprises a semiconductor fabrication chamber, and the fluid is delivered to the chamber to facilitate cleaning and removal of one or more components from semiconductor substrates disposed in the chamber.

32. The method of claim 19, further comprising:
facilitating the delivery of a first fluid stream from the purification section to a second purification section including at least one purification unit;
facilitating the delivery of a second fluid stream from the process station to the second purification section including the at least on purification unit; and
separating at least a portion of at least one component from at least one of the first fluid stream and the second fluid stream in the at least one purification unit of the second purification section.

33. The method of claim 32, further comprising:
selectively alternating the fluid flow from the process station directly to the buffer tank and the second purification section via a controller.

34. The method of claim 32, further comprising:
facilitating a measurement of the fluid pressure via a pressure sensor located downstream from the process station, the pressure sensor being in communication with the controller;
providing a first valve disposed along and in fluid communication with a first fluid supply line that is configured to connect the process station with the buffer tank, the first valve being in communication with the controller;
providing a second valve disposed along and in fluid communication with a second supply line that is configured to deliver the second fluid stream from the process station to the second purification section, the second valve being in communication with the controller; and
selectively alternating the opening and closing of each of the first and second valves, via the controller, based upon pressure measurements determined by the pressure sensor.

35. The method of claim 19, wherein the at least one purification unit comprises at least one of an adsorption unit, an oxidation unit, a distillation unit, an absorber unit, a filter, a coalescer and a mechanical separation unit.

36. The method of claim 19, further comprising:
recycling fluid processed by the purification section to the process station.

37. The method of claim 19, wherein fluid is delivered from the buffer section to the at least one purification unit at a flow rate that is maintained within a predetermined range.

38. A method of purifying a fluid for use at a process station comprising:
facilitating a supply of fluid to a process station via a fluid supply source;
facilitating delivery of the fluid from the process station to a purification section including at least two purification units; and
separating at least a portion of at least one component from the fluid in each of the purification units while the fluid is maintained in at least one of a supercriticai state and a liquid state.

39. The method of claim 38, wherein each purification unit comprises at least one of an adsorption unit, an oxidation unit, a distillation unit, an absorber unit, a filter, a coalescer and a mechanical separation unit.

40. The method of claim 38, wherein the process station comprises a semiconductor fabrication chamber, and the fluid is delivered to the chamber to facilitate cleaning and removal of one or more components from semiconductor substrates disposed in the chamber.

41. A method of purifying a fluid for use at a process station comprising:
facilitating the delivery of fluid from the process station to a buffer section;
maintaining the fluid within the buffer section in at least one of a gas state, a liquid state and a supercritical state;
facilitating the delivery of fluid from the buffer section to a purification section including at least one purification unit, wherein fluid is delivered from the buffer section to the at least one purification unit at a flow rate that is maintained within a predetermined range; and
separating at least a portion of at least one component from the fluid in the at least one purification unit of the purification section.

42. The method of claim 41, wherein the process station comprises a semiconductor fabrication chamber, and the fluid is delivered to the chamber to facilitate cleaning and removal of one or more components from semiconductor substrates disposed in the chamber.

43. A fluid purification and recovery system comprising:
a means for receiving a fluid delivered from a process station, maintaining the pressure of the fluid within a predetermined range, and further maintaining the fluid in at least one of a gas state, a liquid state and a supercritical state; and
a purification section disposed downstream from the means for receiving, the purification section including a means for separating at least a portion of at least one component from the fluid.

44. The system of claim 43, wherein the means for receiving delivers fluid to the purification section at a pressure that fluctuates no more than about 10% from a preselected pressure value.

45. The system of claim 43, wherein the process station comprises a semiconductor fabrication chamber, and the fluid is delivered to the chamber to facilitate cleaning and removal of one or more components from semiconductor substrates disposed in the chamber.

46. A fluid purification and recovery system comprising:
a semiconductor fabrication chamber configured to receive a fluid in a supercritical state and clean and remove one or more components from semiconductor substrates disposed in the chamber;
a buffer section configured to receive fluid delivered from the chamber, wherein the fluid pressure is maintained within the buffer section within a predetermined range and the fluid is maintained within the buffer section in at least one of a gas state, a liquid state and a supercritical state; and
a purification section disposed downstream from the buffer section to receive the fluid from the buffer section and including at least one purification unit that separates at least a portion of at least one component from the fluid.

47. A fluid purification and recovery system comprising:
a semiconductor fabrication chamber configured to receive a fluid in a supercritical state and clean and remove one or more components from semiconductor substrates disposed in the chamber;
a fluid supply source connectable at an upstream location with the chamber to provide fluid to the chamber; and
a purification section including at least two purification units located at a downstream location from and connectable with the chamber to receive fluid exiting the process station;
wherein the purification units of the purification section remove at least one of the components from the fluid while the fluid is maintained in at least one of a supercritical state and a liquid state.
